(19) United States
(12) Patent Application Publication
(10) Pub. No.: US 2012/0020641 A1
(43) Pub. Date: Jan. 26, 2012

(54) CONTENT REPRODUCTION APPARATUS

(76) Inventors: Hidenori SAKANIWA, Yokohama (JP); Takahiko Nozoe, Yokohama (JP); Yukinori Asada, Chigasaki (JP); Mayumi Nakade, Yokohama (JP); Tomoaki Yoshinaga, Sagamihara (JP)

(21) Appl. No.: 13/167,755

(22) Filed: Jun. 24, 2011

(30) Foreign Application Priority Data
Jul. 23, 2010 (JP) 2010-165460

(51) Int. Cl. H04N 5/775

(52) U.S. Cl. 386/230; 386/E05.07

(57) ABSTRACT

The content reproduction apparatus comprises: an input unit to which a content is input; a reproduction position recording unit to record a reproduction position of a content being reproduced; a display unit to display the content; a sensor to detect a human's presence or absence in or from a predetermined area; and a timer to measure a time period of a human's absence from the predetermined area detected by the sensor; wherein, if the sensor detects a human's absence from the predetermined area, the reproduction position of the content being reproduced is recorded in the reproduction position recording unit and, according to the time period measured by the timer, the content reproduction apparatus is configured to control whether or not to present a screen image prompting to start reproducing the content from the reproduction position recorded in the reproduction position recording unit.

### INCORPORATION BY REFERENCE

The present application claims priority from Japanese application JP 2010-165460 filed on Jul. 23, 2010, the content of which is hereby incorporated by reference into this application.

### BACKGROUND OF THE INVENTION

The present invention relates to a reproduction of a video signal and an audio signal.

JP-A-2001-84662 takes it, as its problem to be solved, to provide such a reproduction device that, “when a user has to temporarily leave where the user is while viewing/listening to a video and/or an audio, the user does not need to perform an operation such as ‘Suspend’ or ‘Stop’; when the user returns and resumes the reproduction, the user does not need to perform any operation to resume reproduction; and, when the user has resumed the reproduction, the user can reliably recognize the audio that the user heard when the device was suspended” (see JP-A-2001-84662, paragraph [0005]). To achieve this problem to be solved, according to JP-A-2001-84662, the reproduction device “comprises: a reproduction means to reproduce an audio signal recorded in a recording medium; an audio output means to output an audio based on the audio signal reproduced by the reproduction means; a detection means to detect whether a user is present within a listening area of the audio output from the audio output means; and a control means; wherein the control means, when the detection means detects that the user is absent from the listening area, suspends the reproduction of the audio signal by the reproduction means, moves a reproduction position on the recording medium a first time period backward and holds the reproduction means standing by in a suspend state; wherein, when the detection means detects that the user is present in the listening area, the control means controls the reproduction means to resume reproduction of the audio signal” (see JP-A-2001-84662, paragraph [0006]).

JP-A-2009-94814 takes it, as its problem to be solved, to provide a display system which “allows the user to view a video content at any place or at any time and, even if the viewing place or time changes, reduces an amount of time spent viewing the video content alone by reducing a chance of viewing again already viewed portions in one video content” (see JP-A-2009-94814, paragraph [0006]). To achieve this problem to be solved, according to JPA-2009-94814, the display system “comprises: a content storage means to store a plurality of video contents including video information; a read control means to instruct the content storage means to start and stop reading the video content and to specify a read start position in the video content when making an instruction on the start of reading; a plurality of display means which are installed at a plurality of locations and which display the video content read out by the read control means from the content storage means; and user detection means which are installed in connection with the display means and which detect the presence or absence of a user who views the display means; wherein the read control means, when there is still a portion of the video content that has not yet been completely output when the reading of the video content is stopped, reads at least that portion of the video content from the content storage means and displays it on another display means associated with the user detection means which detects the user's presence (see JP-A-2009-94814, paragraph [0007]).

### SUMMARY OF THE INVENTION

JP-A-2001-84662 discloses, for example, that if a user leaves the viewing/listening area, the content reproduction is temporarily suspended, and, if the user returns, is resumed, and that even if two or more users are in the viewing/listening area and one of them leaves there, the reproduction continues. However, where the content reproduction is continued when one of the users leaves the viewing/listening area, JP-A-2001-84662 does not take any considerations as to a scene that the user in question missed viewing while the user was absent.

In JP-A-2009-94814, so as to allow the user to view at any other place or destination a portion of a video content that has not yet been output completely, a method is described to generate chapters by estimating, based on the presence or absence of the user, to which position the video content has been reproduced. However, JP-A-2009-94814 does not take any considerations as to processing and power saving that need to be performed following the recording of a head position of a scene the user wants to view, a specific method of notifying the user how the user can view the scene, or a control of combining user operations and user detection information.

To solve the above problem, the first embodiment of this invention is configured to comprises: an input unit to which a content is input; a reproduction position recording unit to record a reproduction position of a content being reproduced; a display unit to display the content; a sensor to detect a human's presence or absence in or from a predetermined area; and a timer to measure a time period of a human's absence from the predetermined area detected by the sensor; wherein, if the sensor detects a human's absence from the predetermined area, the reproduction position of the content being reproduced is recorded in the reproduction position recording unit, and, according to the time period measured by the timer, the content reproduction apparatus controls whether or not to display a screen image prompting to start reproducing the content from the reproduction position recorded in the reproduction position recording unit.

The above configuration for the reproduction of an audiovisual content, etc. produces such effects as to reduce power consumption and to enhance usability for the user.

Other objects, features and advantages of the invention will become apparent from the following description of the embodiments of the invention taken in conjunction with the accompanying drawings.

### BRIEF DESCRIPTION OF THE DRAWINGS

FIG. 1 shows a configuration example of a content reproduction apparatus of this invention.

FIG. 2 shows an example of processing performed by the content reproduction apparatus.

FIG. 3 shows an example of chapter file structure generated by the content reproduction apparatus.

FIG. 4 shows an example of processing performed by the content reproduction apparatus.

FIG. 5 shows an example of processing performed by the content reproduction apparatus.

FIG. 6 shows an example of processing performed by the content reproduction apparatus.

FIG. 7 shows an example of processing performed by the content reproduction. apparatus.

FIG. 8 shows an example of processing performed by the content reproduction apparatus.

FIG. 9 shows an example of processing performed by the content reproduction apparatus.

FIG. 10 shows an example of processing performed by the content reproduction apparatus.

FIG. 11A shows an example of processing performed by the content reproduction apparatus.

FIG. 11B shows an example of processing performed by the content reproduction apparatus.

FIG. 12A shows an example of screen image displayed by the content reproduction apparatus.

FIG. 12B shows an example of screen image displayed by the content reproduction apparatus.

FIG. 12C shows an example of screen image displayed by the content reproduction apparatus.

FIG. 12D shows an example of screen image displayed by the content reproduction apparatus.

FIG. 12E shows an example of screen image displayed by the content reproduction apparatus.

FIG. 12F shows an example of screen image displayed by the content reproduction apparatus.

FIG. 13A shows an example of screen image displayed by the content reproduction apparatus.

FIG. 13B shows an example of screen image displayed by the content reproduction apparatus.

FIG. 14 shows an example of screen image displayed by the content reproduction apparatus.

FIG. 15 shows an example of processing performed by the content reproduction apparatus.

FIG. 16 shows an example of chapter file structure generated by the content reproduction apparatus.

FIG. 17A shows an example of processing performed by the content reproduction apparatus.

FIG. 17B shows an example of processing performed by the content reproduction apparatus.

FIG. 18 shows an example of screen image displayed by the content reproduction apparatus.

FIG. 19A shows an example of screen image displayed by the content reproduction apparatus.

FIG. 19B shows an example of screen image displayed by the content reproduction apparatus.

FIG. 20 shows an outline example of one embodiment of this invention.

FIG. 21 shows an example of chapter file structure generated by the content reproduction apparatus.

### DESCRIPTION OF THE EMBODIMENTS

Now, embodiments of this invention will be explained by referring to the accompanying drawings.

### First Embodiment

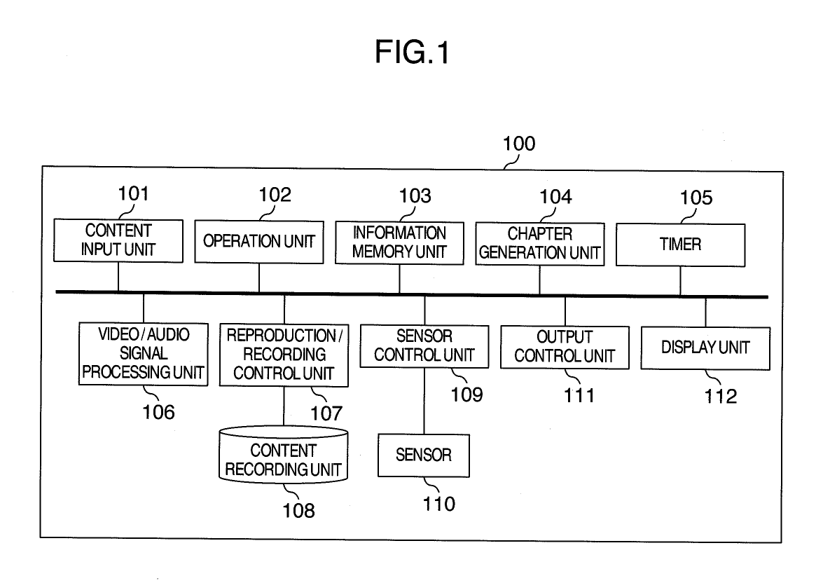

FIG. 1 shows a configuration example of the content reproduction apparatus in this embodiment.

In FIG. 1, reference numeral 100 represents a content reproduction apparatus, 101 a content input unit, 102 an operation unit, 103 an information memory unit, 104 a chapter generation unit, 105 a timer, 106 a video/audio signal processing unit, 107 a reproduction/recording control unit, 108 a content recording unit, 109 a sensor control unit, 110 a sensor, 111 an output control unit, and 112 a display unit. Although, in FIG. 1 the respective units 101 to 112 are independent of each other, they may comprise one or more of elements. For example, the units 104, 106, 107, 109 and 111 may be configured so that one or more CPUs can perform the processing of the respective units.

The content input unit 101 is an interface capable of inputting contents such as video, audio and texts which is constructed of a tuner for receiving video, audio and EPG (electronic program guide) data in broadcast waves from radios, TVs and CATVs; an optical disc player or a game machine; or an external input device to receive contents from the Internet.

The operation unit 102 is an interface constructed of a light receiving unit and an operation panel to receive signals from a remote controller so that the operation unit can accept the user's operation.

The information memory unit 103 is constructed of a nonvolatile or volatile memory device and to store parameters set by the user manipulating the operation unit, chapter information described later, etc.

The chapter generation unit 104 determines the viewing situation of a human within a detection area (in which the human's presence or absence is detected) from the sensor control unit 109 to generate chapters in a content. Although a chapter is explained as the reproduction position of the content in this embodiment, a time code or resume point may also be recorded as the content reproduction position.

The timer 105 manages clock time information and has a function of measuring the time period from any desired timing. It is used to measure a clock time when the sensor has produced its output and a time period for which a human was absent, and to control the content reproduction time period.

The video/audio signal processing unit 106 performs the processing such as decoding contents from the content input unit 101, encoding the contents in the content recording unit 108, and converting video and audio in response to the requests from the output control unit 111.

The reproduction/recording control unit 107 controls a content reproduction operation, such as “Reproduction”, “Suspend”, “Stop”, and “Chapter-Jump”, in response to the user's operation on the operation unit 102 and according to the chapter information, and encodes a content to record the content in the content recording unit 108 through an interface. It also manages the content reproduction position (chapter positions, the number of reproduction frames, the reproduction time period elapsed from the head of the content, etc.)

The content recording unit 108 is constructed of a memory of semiconductor devices, such as a hard disk drive (HDD) and a solid state drive (disk) (SSD), which has a directory structure so that the content can be recorded in units of file and read from a position specified by a request.

The sensor control unit 109 controls the sensor 110 to process the information output from the sensor. When using a camera sensor or a microphone sensor, the video/audio signal processing unit 106 extracts features from the video and audio delivered from the sensor 110. To reduce the processing load in the video/audio signal processing unit 106, the sensor control unit 109 may have another video/audio signal processing unit.

The sensor 110 is constructed of a human sensor, a camera sensor, a microphone sensor, or the like to detect a human's presence or absence in the detection area, the viewing situation, the number of viewers, the viewer identification, or the like. Other types of sensors may be employed as long as they can detect a human's presence.

The output control unit 111 controls output to a video display device such as a panel, and to an audio output device such as a speaker, according to the requirement of these devices. The output control unit 111 can realize energy saving by, for example, turning off the power of the display unit 112, stopping displaying a video on the display unit 112 (blanking out the screen) or lowering the brightness of the display unit 112. When turning off the power of the display unit 112 or stopping displaying a video on the display unit 112 (blanking out the screen), outputting the video signal to the display unit 112 may be halted.

The display unit 112 is an interface to output a video signal and an audio signal to a display device such as liquid crystal, organic EL, plasma or LED, or to an external display device. According to the instructions from the output control unit 111, the display unit 112 displays audio, text information, etc. for the user.

If the display unit 112 is configured as an interface for outputting video and audio signals to an external display device, the output control unit 111 can realize the same power saving like when the display unit 112 is a display unit such as liquid crystal, organic EL, plasma or LED, by sending to the destination display an instruction of turning off power, by stopping displaying a video on the display unit 112 (blanking out the screen), or by reducing the brightness.

This configuration allows the user to easily search for a scene of the video/audio content that the user missed viewing while the user was absent from the viewing/listening area (or the viewing area), by generating and adding a chapter to that scene. The missed scene can also be recorded to be reviewed later.

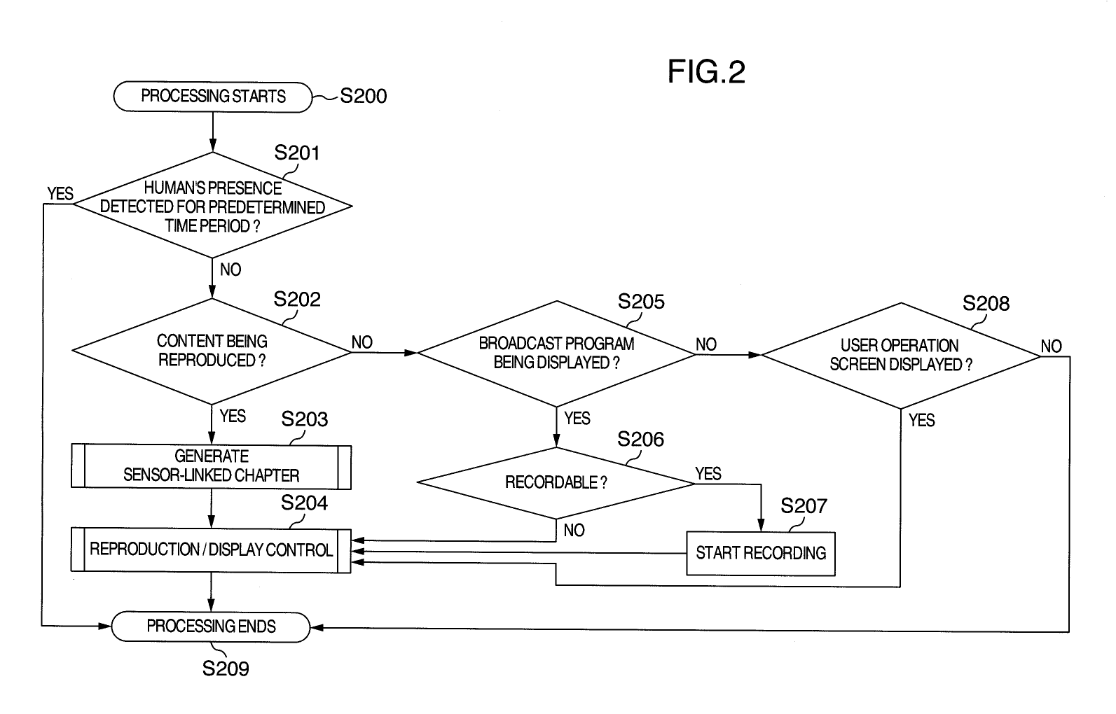

FIG. 2 shows an example of processing performed in the content reproduction apparatus of this embodiment.

If the sensor control unit 109 detects that a human is absent in the detection area (S201), based on the situation where no sensor output is received or where the sensor output received is less than a specified threshold continuing for a predetermined time period, then the content reproduction apparatus at S202 checks whether a content is being reproduced. If the content is being reproduced, the content reproduction apparatus generates a chapter (a sensor-linked chapter) (S203).

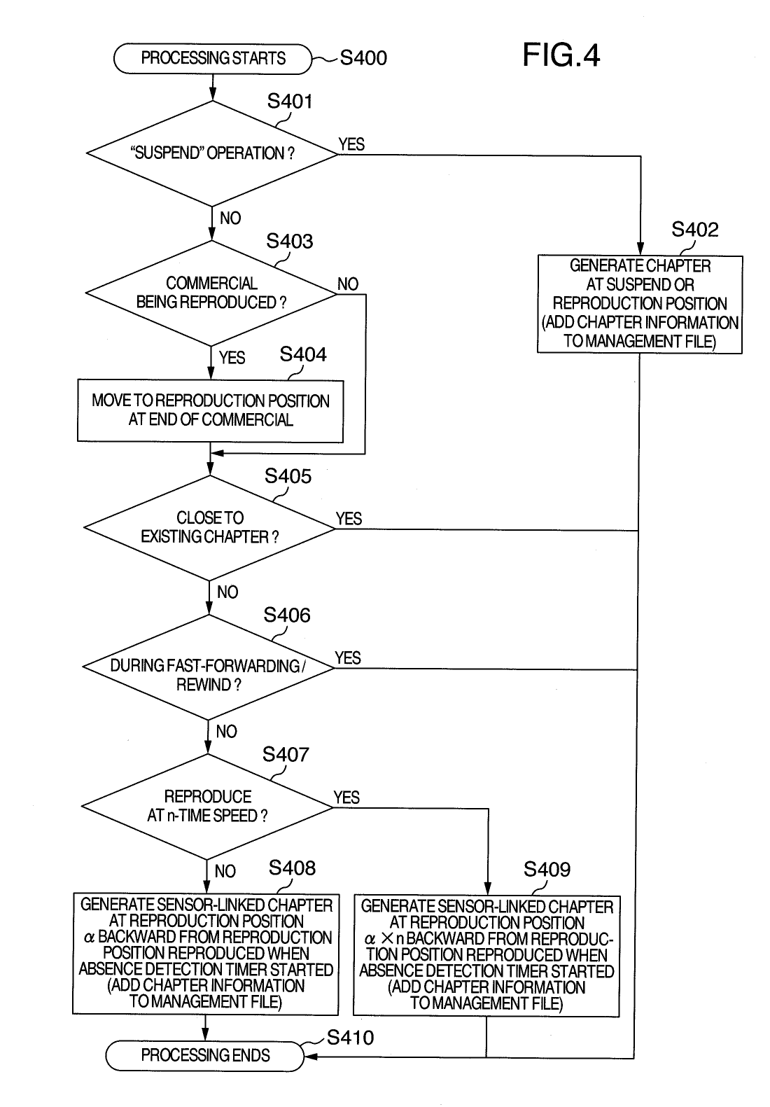

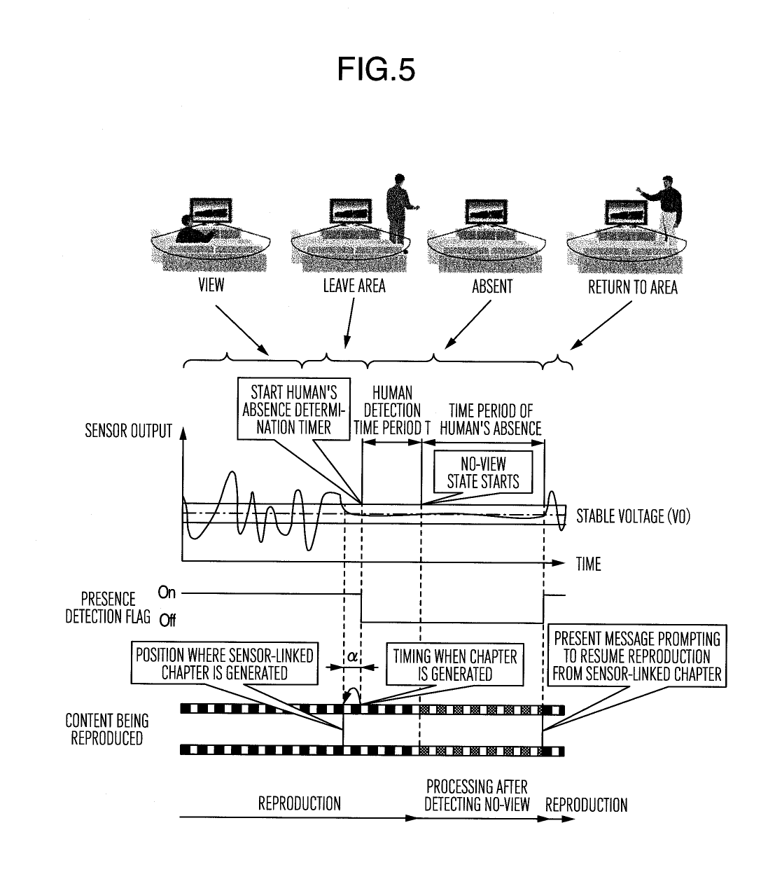

When generating the sensor-linked chapter, the content reproduction apparatus generates the chapter at a reproduction position reproduced at the timing when the sensor control unit 109 starts determining whether a human is absent in the detection area (human's absence determination timer start timing), or at a reproduction position a few seconds prior to the timer start timing. This allows the user to resume reproduction from the head of the scene that the user missed viewing while the user was absent, or a little backward therefrom. The timer start timing will be explained later by referring to FIG. 4 and FIG. 5.

After this, since the sensor control unit 109 determines that a human is absent, the content reproduction apparatus performs a reproduction/display control (S204) by stopping reproduction to change it to an energy saving mode, etc.

Therefore, for example, even if, when a user leaves the room (viewing area) while reproducing a content, the content reproduction apparatus can generate a chapter in the content being reproduced at the timing when the user left the room (or at a little earlier timing therefrom). This not only realizes energy saving but also produces such an effect that the user can resume when the user returns to the room (viewing area), the reproduction of the content from the scene that the user missed viewing when the user left the room. The viewing area is a range (detection area) where the sensor can detect a human's presence or absence or a predetermined part of that range (detection area), etc.

If, at S201, the sensor control unit 109 detects a human's presence, the chapter is not generated. If, at S202, the content is not being reproduced, it is determined whether a broadcast program is being displayed (S205). If the broadcast program is being displayed, then it is determined whether the content reproduction apparatus is in an unrecordable state where it cannot record the program (S206).

The possible unrecordable states include, for example, a state where the content reproduction apparatus is already recording a program and so cannot record other programs; a state where the content reproduction apparatus has been already programmed to record and, if the content reproduction apparatus starts recording the program being displayed, the preset program will be made unrecordable; or a state where the content recording unit 108 has too little space to record any more program.

If, at S206, the content reproduction apparatus determines that the content reproduction apparatus is unrecordable, the content reproduction apparatus, at 5204, controls displaying the currently selected broadcast program. If, at S206, it determines that the content reproduction apparatus is recordable, it starts recording the program being displayed (S207). Then, at 5204, the content reproduction apparatus performs the display control such as keeping the currently selected broadcast program displayed for the user viewing or blanking out the screen for energy saving.

Even if the user leaves the room (viewing area) while displaying the broadcast program, this enables the content reproduction apparatus to automatically start recording the broadcast program currently being displayed. As a result, along with realizing energy saving, when the user returns to the room (viewing area), the user can view the scene that the user missed viewing while the user was absent.

If, at 5205, a window or screen used for user's operation (user operation window) such as a menu is displayed rather than a broadcast program, it is highly likely that the window will not be used because of the user's absence, so that the content reproduction apparatus may stop displaying the user operation window and change to the state of displaying the broadcast program. Since most of the user operation window is displayed as a still image, this configuration produces such an effect as to prevent a still image part on the user operation window from burning out.

The processing explained with reference to FIG. 2 enables a chapter to be added to the content being reproduced at a position near the timing when the user has become absent (has left the viewing area) while the content is reproduced. This produces such an effect that, when the user returns to the viewing area, the user can easily find the missed scene by selecting the chapter.

Further, where a broadcast program is viewed, the above processing enables a scene, which may otherwise be missed, to be automatically recorded. So, when the user returns to the viewing area, the user can reproduce and view the missed scene.

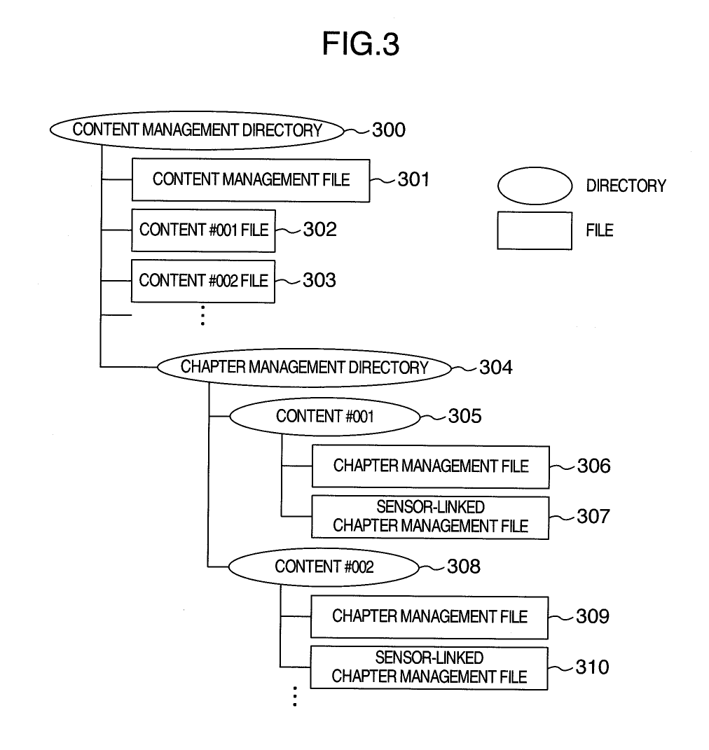

FIG. 3 shows an example of chapter file structure generated by the content reproduction apparatus of this embodiment.

Video data is recorded as a file in a file system in the content recording unit 108 such as HDD. According to the user's recording setting or automatic recording operation, a broadcast program, etc. is recorded as a file. The content reproduction apparatus reads the file from the content recording unit 108 and reproduces it when the user wants to view the program.

In a digital broadcast, for example, a content is transmitted in TS (Transport stream) of MPEG 2 (Moving Picture Experts Group 2) from a broadcasting station to a receiver, and then stored on HDD as TS or PS (Program stream). By storing the content as a file and adding to the file a lot of information as described above, many utility functions can be provided to users.

In this embodiment, a content file and its management information are stored in the content recording unit 108. Data is managed in a treelike structure, and the content and the chapter information are managed by the content management directory 300.

The content management directory 300 has, for example, the content management file 301, the content #i (i is an integer) files (302, 303) and the chapter management directory 304. Under the chapter management directory 304, for example, the content #i directories (305, 308) are arranged. For example, under each content #i directory, the chapter management files (306, 309) and the sensor-linked chapter management files (307, 310) are arranged. It is noted that this structure is shown only as an example and may also include other directories and files.

The content management file 301 manages the relation among files and file attributes (genres, program information, number of copies, copyright protection, compression format, etc.). The relation among files is file reference such as the chapter information of the content #001 file referring to the chapter management file 306 and the sensor-linked chapter management file 307 under the content #001 directory 305 under the chapter management directory 304.

The content #i files (302, 303) store data streams of the content that the user views. The chapter management directory 304 is a directory that contains the chapter management file strung to each content #i file.

The chapter management files 306 and 309 are files of chapter information added to the content when it is encoded and recorded. The chapters are inserted into the content where a stereo broadcast and a monaural broadcast are switched, where the scene changes greatly, and where a captioned broadcast and non-captioned broadcast are switched, in order to aid the user's operation for reproducing the content.

If, for example, a chapter is inserted at the head and end of commercials (CM) , etc. broadcasted between programs, then the user can skip the commercials to view only the programs. The chapter information in the chapter management files 306 and 309 has already been implemented using many techniques. The chapters may be inserted automatically by the content reproduction apparatus according to the subject of the content, or manually by the user.

The sensor-linked chapter management files 307 and 310 are files to manage chapters generated according to the user's viewing/listening situation (or viewing situation) as detected by a sensor such as a human sensor or a camera sensor. These files store, as chapters, reproduction positions, etc. in the content at the time when the user leaves the viewing area while the content is reproduced. As to the storage of chapters, two or more chapter positions may be recorded as separate chapters or as a single chapter.

Recording a plurality of chapters is convenient for a user who wants to view all the scenes that the user missed viewing while the user was absent. Recording them as a single chapter and always overwriting the start position of the latest scene that the user missed viewing when the user last left the viewing area is convenient for a user who wants to view only the most recently missed scene.

In addition to the chapter management files 306 and 309 in this embodiment, there are the sensor-linked chapter management files 307 and 310. This makes it possible to use chapters according to the viewing situation while keeping the convenience of existing chapters, and to improve the usability of the content reproduction apparatus.

The sensor-linked chapter management files may also store the date and time when the chapter was generated and the time period for which the user missed viewing the content. This makes it possible to check when the user was absent and missed viewing the content. Even if such an individual identification function as illustrated in a second embodiment is not provided, the user can estimate, from the date and time or the time slot when the user was absent whether the scene in question is the one the user missed viewing. If the time period for which the user missed viewing the content is known, the user may use this information to decide not to view again the short missed scene.

The content management file 301 and the sensor-linked chapter management files 307 and 310 which string together the content files and the chapter management information may be stored in the content recording unit 108 or the information memory unit 103, etc.

Further, if the user goes out carrying a portable video player with contents, and, at a destination, enjoys viewing a content, then the user may take not only the content but also the content management file. This produces such an effect as to facilitate searching for the scene that the user missed viewing at home by using the sensor-linked chapters.

While this embodiment is configured to separate the chapter management files and the sensor-linked chapter management files, if the chapters inserted according to the subject of the content or inserted by the user and the chapters inserted in response to the sensor detection, i.e., according to the viewing situation, can be managed separately, then the information of these chapters may be stored in the same file.

FIG. 4 shows an example of processing performed in the content reproduction apparatus of this embodiment.

This processing is a concrete example of the chapter generation processing performed by S203 of FIG. 2, and is a reproduction control operation in the case where the user leaves the room or the viewing area while reproducing a recorded program, etc.

At S400, the content reproduction apparatus starts the chapter generation sequence which, at S401, checks whether the user has done a “Suspend” or “Stop” operation before the user leaves the viewing area. If the “Suspend” or “Stop” operation has been done, S402 generates a sensor-linked chapter at the reproduction position reproduced when the “Suspend” or “Stop” operation has been done. This is because, from the fact that the user has done the “Suspend” or “Stop” operation at that position, it is expected that the user may want to resume reproduction operation from that position.

If the user has done the “Suspend” or “Stop” operation and the sensor has detected that the user was absent from the viewing area, turning off the backlight of the display unit to blank out the screen is effective to reduce power consumption.

In order to reduce power consumption, the output control unit 111 may be instructed to blank out the screen or cause the content reproduction apparatus to change to a standby state according to the time period for which the user was absent. If, at this time, a sensor-linked chapter is generated, then the content reproduction, when resuming reproduction of the content suspended or stopped, can be resumed from the position. If a flag, which is used to indicate that the user has done the “Suspend” operation, is set in the sensor-linked chapter, then the time period elapsed until blanking out the screen may be set shorter.

If, at S401, the user has not done the “Suspend” operation, the chapter generation sequence, at S403, checks whether a commercial is being reproduced. Whether the reproduction position is in a commercial or not is determined by detecting no caption information, no SAP channel, or switching between monaural audio and stereo audio.

During the commercial, the user may want to go to the bathroom. If so, the chapter generation sequence issues to the output control unit 111 an instruction to blank out the screen during the commercial, and, when it detects the end timing of the commercial, generates a sensor-linked chapter (S404). If the user returns during the commercial, the chapter generation sequence presents to the user a message that allows the user to select either to continue watching the commercial or to skip it and proceed to the program content.

When the user returns after the commercial ended and the program content resumed, the chapter generation sequence presents to the user a message indicating that the program content can be rewound to the chapter generated at the position where the program content restarts following the commercial.

If, at S403, a commercial is not being reproduced, S404 is not performed. In this example, a commercial is currently being reproduced. But at positions where the user is considered unlikely to view, by using the chapters, missed scenes such as a staff roll shown at the end of the content, a scene immediately preceding the commercial already viewed but once again inserted immediately following that commercial, and a scene already viewed but being reproduced again, chapters may not be generated. For a user who wants to view commercials, the sensor-linked chapters may be added even to the commercials by the user's selection, etc.

At S405, if, after checking the existing chapters in the chapter management files 306 and 309, the position where a sensor-linked chapter is to be generated is close to an existing chapter (for example, in the frame within a predetermined time period such as 30 seconds from the existing chapter), then the new chapter may not be generated.

This is because, if a plurality of chapters are set close together, then, when the user attempts to move the reproduction position to a forward or backward chapter, the user will have to jump to similar scenes repetitively before the user can move to the desired chapter. This increases the number of user's operations and the operation time and results in a possible degraded usability.

At S406, it is checked whether the content being reproduced is in a special reproduction state such as a Fast-forwarding operation and a Rewind operation. In this case, since it is conceivable that the user, for some reason, leaves the viewing area while searching for a reproduction position and the sensor determines that the user is absent, the processing for Suspend or Stop is performed instead of letting the special reproduction operation continue, and also an instruction is issued to the output control unit 111 to blank out the screen.

If the user returns, a video may be displayed on the screen and a message on the screen asking whether the user wants to resume the operation that the user was doing before the user left may be displayed. This can prevent the reproduction position from moving forward or backward beyond the user's expectation. Alternatively, at the timing when determining the user's absence, it is possible to store the clock time simultaneously with generating a chapter, and to notify the user of the clock time when the user left. This offers the advantage of helping the user remember the operation that the user was doing from the clock time information. At S407, it is determined whether the user listens to its audio during reproduction at 1.3-time speed, or views the content reproduced at n-time speed such as double time speed, etc. If reproduction is not being performed at n-time speed, a sensor-linked chapter is generated (S408).

The sensor control unit 109 determines that the user is absent, if no larger sensor reaction than a predetermined threshold has not been detected for a predetermined time period after the sensor began to detect the user's absence. It generates a sensor-linked chapter at a reproduction position a predetermined time period a backward from when the timer for measuring the time period up to the determination of absence starts. The sensor control unit 109 then adds the chapter information to the sensor-linked chapter management files 307 and 310 of FIG. 3.

This offers the advantage of storing a start point of the missed scene, because the sensor-linked chapter is generated if the human's absence from the viewing area is detected in the human detection control using the sensor.

As the information on the chapter generation position, a content reproduction frame number or a reproduction time period elapsed from a reproduction start position of a content stream are used. The chapter generation position may be in units of frame or GOP (Group Of Pictures) used when digitally recording a video.

Alternatively, a picture at the chapter generation position may be used as a thumbnail which is strung to a sensor-linked chapter management file. This offers the advantage that the user can pick up the missed scene by looking at the thumbnail.

If, at S408, the content was reproduced at n-time speed, then, although the time period elapsed until the sensor control unit 109 determines the user's absence is the same as at normal speed, the reproduced amount of the content is n times greater than at normal speed. So, a sensor-linked chapter is generated at a reproduction position α×n (i.e., n times that of S408) backward (S409). Whether the content was being reproduced at normal speed or at double speed when the user left the viewing area, a chapter, when the user returns, has already been generated at a reproduction position reproduced when the sensor detected the user leaving the viewing area. The user then can easily start viewing the scene that the user missed viewing while the user was absent, by choosing the sensor-linked chapter. Further, when the user selects the sensor-linked chapter generated during reproduction at n-time speed, the content reproduction at n-time speed may resumed, or it may be asked the user whether the user wants to resume reproduction at n-time speed or at normal speed.

As to the generation of a sensor-linked chapter, it has been explained that the chapter is generated at a reproduction position a predetermined time period α backward from when the sensor began to detect the human's absence. This embodiment may also be configured to generate the sensor-linked chapter at the reproduction position reproduced when the sensor began to detect the human's absence.

FIG. 5 shows an example of processing performed by the content reproduction apparatus of this embodiment, and, in particular, an example of chapter generation operation in the case where a human (a user), while reproducing a recorded content, left a sensor detection area and then returns to the area.

Suppose that the user in a sensor detection area is watching TV. At this time, the user watching TV makes various body movements such as laughing, changing the user's leg positions and scratching the user's head, causing the sensor to continually produce sensor outputs. The sensor control unit 109, judging from the sensor output, determines whether a human is present or absent and sets a presence detection flag of the sensor (ON if the sensor detects a human's presence, and OFF if it does not).

Where the sensor used is a pyroelectric human sensor, it gathers infrared rays from the detection area. Where it detects a change in infrared rays (heat source), the sensor produces a pyroelectric effect to produce a potential difference. Where there is no movement in the heat source in the detection area, the sensor has a characteristic of outputting a stable voltage V0.

If the sensor continues to output a value within the range between a threshold and the stable voltage V0, the sensor control unit 109 estimates the human's absence in the detection area and sets the presence detection flag to OFF. If the sensor outputs a value exceeding the threshold, the sensor control unit 109 estimates the human's presence and sets the presence detection flag to ON.

Where a camera sensor is used as the sensor, the camera shoots the viewer from the television and a cover area of the camera becomes the sensor detection area. A face detection processing is performed in the detection area, and, if a face is detected, it is determined that a human is present in the area.

It is also possible to detect a moving body such as a human if there is a change in pixel or block between frames. Based on a shape or size of a moving part, it can be estimated whether a human or a small animal such as a pet moves, and whether a human is present or absent in or from the detection area. In this case of detecting the moving body, too, a threshold is predetermined for the amount of movement occupied in the camera's entire imaging range, and, if the movement detected is greater than a threshold, the presence detection flag is set to ON since it is estimated that a human is present in the detection area, and, if the movement is less than the threshold, the presence detection flag is set to OFF.

It is noted, however, that room lighting turned on or off and external light entering from windows may cause large changes in brightness between frames, inadvertently resulting in the presence detection flag changing between ON and OFF. So, in order to keep the presence detection flag from being affected by large changes in the entire camera imaging range, it may also be determined based only on the subsequent movements whether the presence detection flag is set to On or OFF.

Next, if the user leaves the sensor detection area, the sensor control unit 109 changes the presence detection flag from ON or OFF in response to the output from the human sensor or camera sensor. At this time, a sensor-linked chapter is generated at a reproduction position a predetermined time period a backward from when the presence detection flag changes from ON to OFF.

By checking the sensor outputs during a predetermined time period T (or a human detection time period) from when the presence detection flag changes from ON to OFF, the sensor control unit 109 checks that nobody really exists in the detection area (or a human's absence). Since there is still a possibility of somebody being present during that checking period, the content reproduction is continued.

If, during the predetermined time period T, the sensor output is less than a predetermined threshold and the presence detection flag remains OFF, then it is highly likely that the content is not being viewed, and thus the processing such as stopping content reproduction and blanking off the screen is performed for energy saving after detecting “No-view”. If the user returns and starts viewing the content, the content reproduction apparatus jumps to the most recent chapter of the generated sensor-linked chapters and presents a message to the user asking whether the user wants to view a scene that the user missed viewing while the user was absent.

As described above, by estimating a human's behavior from the sensor outputs and generating a chapter at the reproduction position reproduced when the sensor detected the human leaving the detection area, it is possible to save energy while the user was absent in the viewing area and, when the user returns, to automatically display a missed scene while the user was absent.

In this embodiment, a recorded program is reproduced. When the user is watching a broadcast program, the content recording may be started from when the presence detection flag changes from ON to OFF. Then, when the user returns to the viewing area, the user is allowed to choose whether or not to view the recorded scene. If the user does not choose it, the recorded content file may automatically be erased. This allows recording a scene that the user missed viewing and deleting the unnecessary recorded scene, and thus realizing both the improved usability for the user and a capacity saving of the content recording unit 108.

In addition to the human sensor and the camera sensor, various types of sensors such as a sound sensor (microphone), a distance sensor and an optical sensor are applicable as a sensor for detecting a human. In the case of a sound sensor, levels of sound made by human activities and of voice of conversations may be used to determine whether or not to generate a chapter. In the case of a distance sensor, the human's presence is detected from a distance change in the detection area. In the case of an optical sensor, if the sensor outputs a luminance signal greater than a threshold depending on clock time information during night hours, it is determined that a room lighting is on and that there are highly likely to be human activities, it is determined, based on the detection of the human's presence, whether or not to generate a chapter. As described above, there is no limitation on the type of sensor used for the detection of the human's presence and any sensor can be applicable to this embodiment as long as it is capable of human detection.

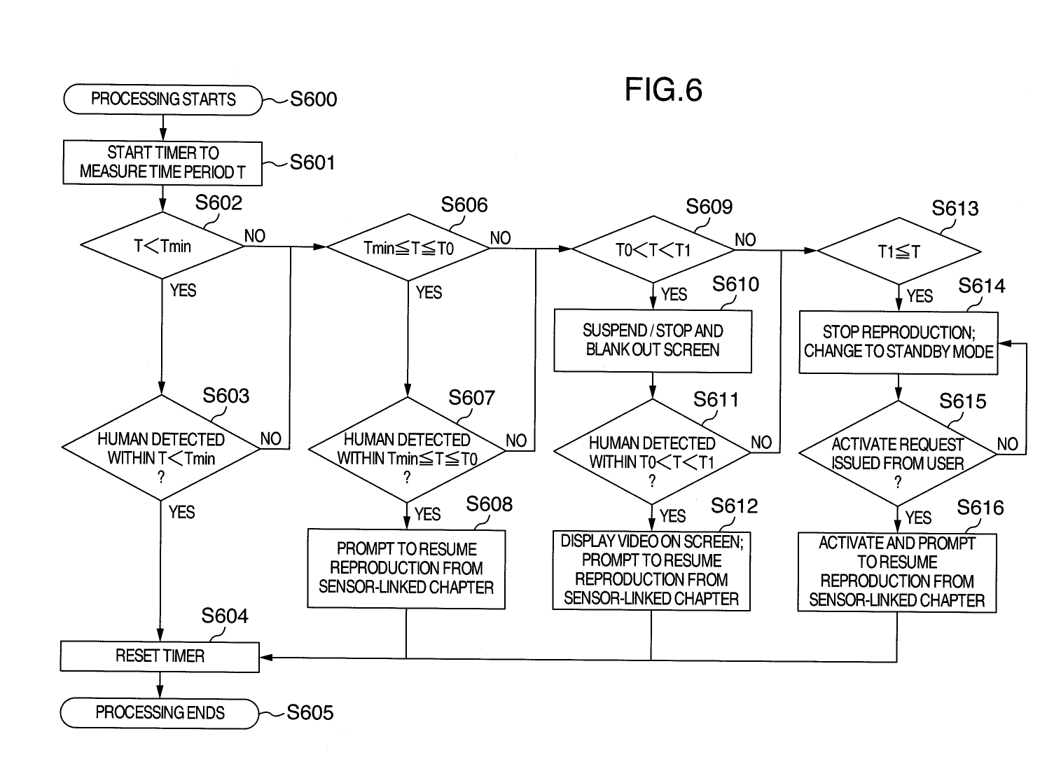

FIG. 6 shows an example of processing performed by the content reproduction apparatus of this embodiment. It shows an example of reproduction processing using a generated chapter.

At the timing when the presence detection flag changes from ON to OFF in FIG. 5, a sensor-linked chapter is generated and a sensor-linked chapter management file is updated. At the same time, a timer starts measuring the time period T elapsed from when the sensor-linked chapter is generated (S601).

At S602, S606, S609 and S613, the time period T for which the user does not view the content is compared with set time periods Tmin, T0 and T1 (0≦Tmin≦T0≦T1) to change the reproduction operation. If the time period T is shorter than Tmin (S602), the content reproduction may be continued. If, during this period, the presence detection flag changes from OFF to ON (S603), like when the user returns to the detection area, then the reproduction operation is continued and any switching to the reproduction using the sensor-linked chapter may not be performed. Then, the timer is reset (S604), and the processing ends (S605) .

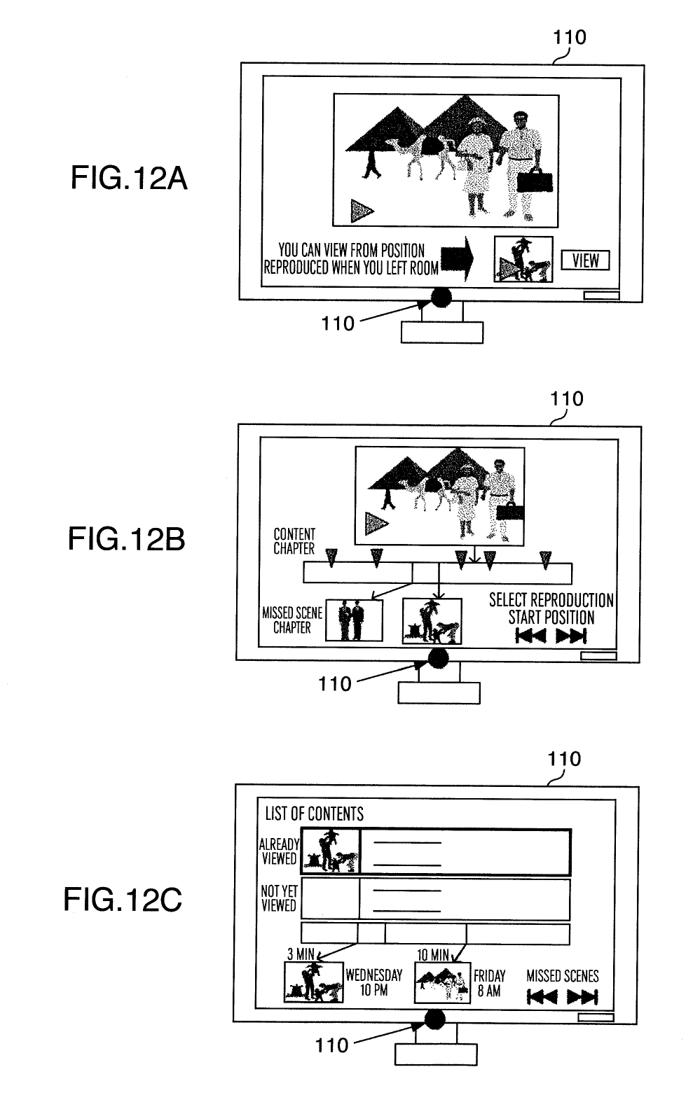

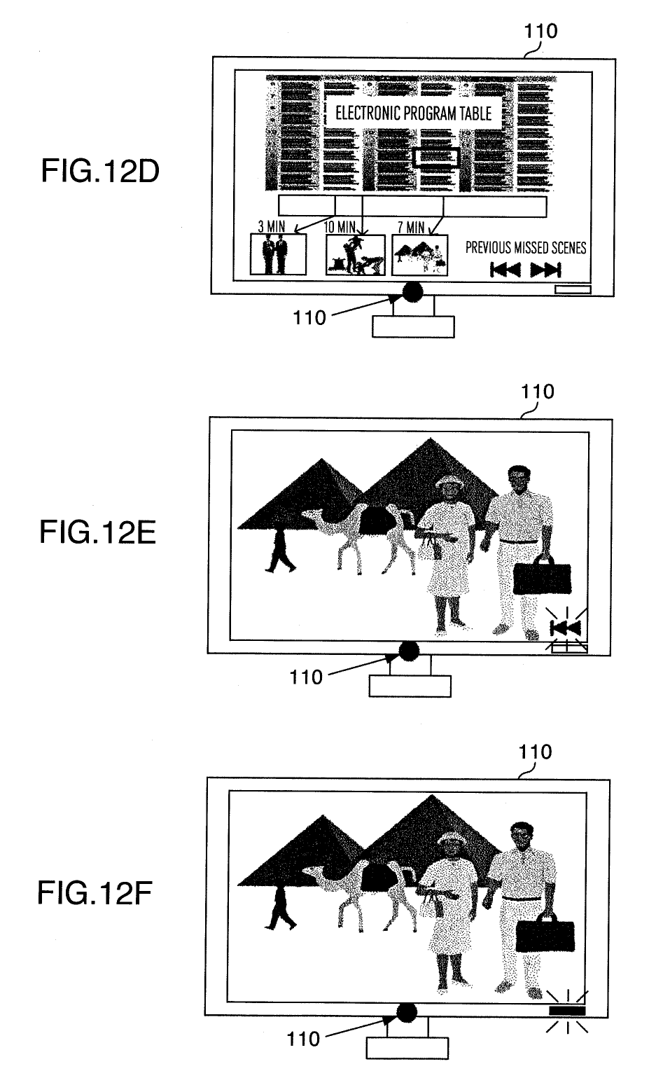

If Tmin≦T≦T0 (S606), the reproduction operation is continued. If, during this period, the presence detection flag changes from OFF to ON (S607), a message is displayed prompting to resume reproduction from the sensor-linked chapter (S608). An example message for prompting to resume reproduction is shown in FIG. 12A to FIG. 12F. This message, designed to help the user view the content, is preferably deleted if the user does not respond to this message in a few seconds, in order to prevent the message from becoming a distraction.

If T0<T<T1 (S609), there is a possibility that the user may not have been viewing the content for a period longer than the set time period T0. So, the content reproduction is temporarily suspended and at the same time the screen is blanked out (S610). When the content reproduction is suspended, the video/audio signal processing unit 106, the reproduction/recording control unit 107 and the content recording unit 108, etc. used for content reproduction, are left activated.

In this way, the content reproduction can quickly be resumed when the user returns to the detection area. For a user who gives priority to energy saving over quick resumption, these functional units may be stopped. To blank out the screen, the output control unit 111 may be used to turn off backlights in the display unit or to stop the self-illuminating process for individual devices. This allows reducing power consumption.

If, within T0<T<T1, the presence detection flag changes from OFF to ON (S611), then backlights are turned on, displaying a video on the screen may be resumed, and, at the same time, a message prompting to resume reproduction from the sensor-linked chapter is displayed (S612). The message prompting to resume reproduction is similar to that of S608.

In this way, if the user has left the detection area, power consumption can be reduced by blanking out the screen, and reproduction of a scene that the user may have missed viewing while the user was absent can be resumed from the head of the scene.

Although, in this example, the user is prompted to resume reproduction of the content, the reproduction may be automatically started from the sensor-linked chapter preceding the Suspend operation based on the sensor-linked chapter management file. In this case, it is possible to automatically display the scene that the user may have missed viewing from the head of the scene when the user, after the user's return to the viewing area, is about to resume reproduction operation.

If T1≦T (S613), the user may not view the content for a period longer than the set time period T1, or may have gone out without turning off the power of the content reproduction apparatus or been taking a nap. So, the content reproduction is stopped and at the same time the content reproduction apparatus changes to the power saving mode such as a standby mode (S614).

The standby mode is a power saving standby state where only a minimum power for the content reproduction apparatus to receive the user's remote control operation is kept turned on. In this state, the content reproduction apparatus can only be started by the user operating the remote control to issue an activate request to the content reproduction apparatus (S615). Upon receiving the activate request from the user, the content reproduction apparatus is activated from the standby mode to display a video on the screen and presents a message prompting to resume reproduction from the sensor-linked chapter (S616). The message prompting to resume reproduction used at this time is similar to that of S608.

The time period T for which the presence detection flag remains OFF after a chapter has been generated is a time period of the scene in the content being reproduced that the user may have missed viewing. So, this period T may be stored in the sensor-linked chapter management file together with the generated chapter. This offers the advantage of being able to present to the user the time period of the missed content so that the user can calculate later how much of the content the user missed viewing.

While FIG. 6 shows a case example where the plurality of processes are performed according to the time period T for which the presence detection flag remains OFF, only some of these processes may be performed.

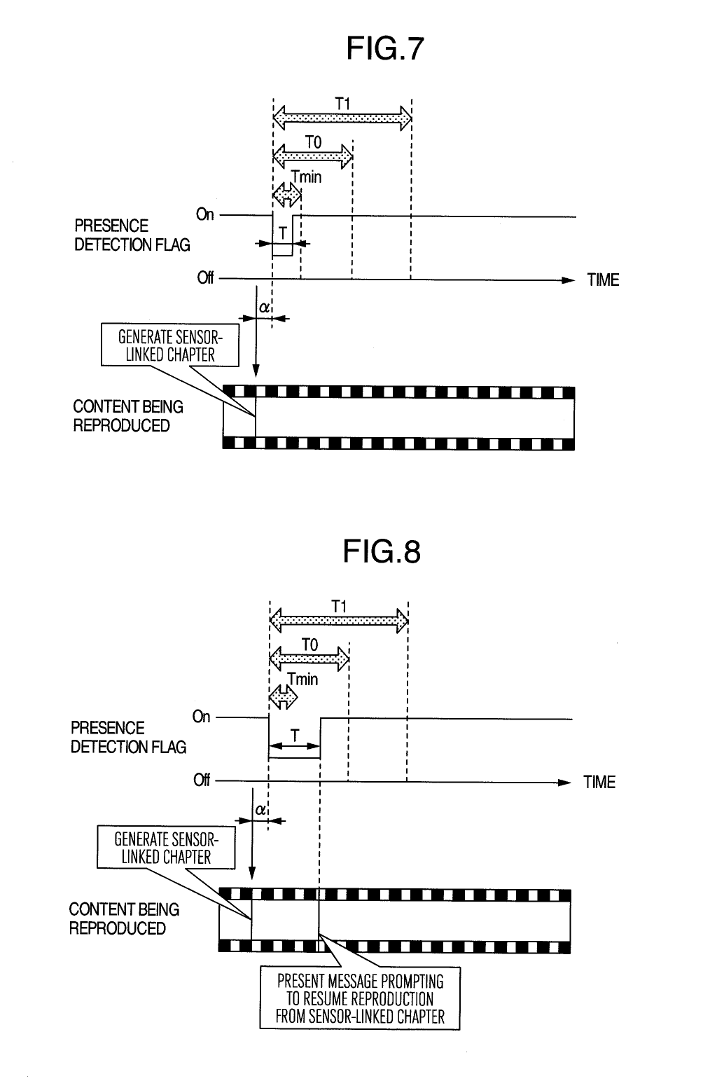

FIG. 7 shows an example of processing performed by the content reproduction apparatus of this embodiment, and, in particular, an example of the content reproduction operation performed by the content reproduction apparatus of this embodiment in the case of T<Tmin of FIG. 6.

FIG. 7 shows an example of operation in the sequence of S602 and S603 of FIG. 6 in which the content reproduction is continued without using the generated sensor-linked chapter.

According to the sensor-linked chapter generation sequence, a sensor-linked chapter is generated at a position a predetermined time period a backward from when the presence detection flag changes from ON to OFF, and the sensor-linked chapter management file is updated.

In this example, the user, after leaving the detection area (viewing area), returns within Tmin, and the presence detection flag changes from OFF to ON within Tmin. In this case, asking the user whether the user wants to reproduce a small section of the content that the user may have missed viewing for a short time period from leaving the detection area to returning there, may degrade the usability. For this reason, a message prompting to resume reproduction from the sensor-linked chapter position may not be presented.

FIG. 8 shows an example of processing performed by the content reproduction apparatus of this embodiment, and, in particular, an example of the content reproduction operation performed by the content reproduction apparatus of this embodiment in the case of Tmin≦T≦T0 of FIG. 6.

FIG. 8 shows an example of operation in the sequence of S606, S607 and S608 of FIG. 6 in which, while the content reproduction continues, the user is prompted to resume content reproduction using the sensor-linked chapter. According to the sensor-linked chapter generation sequence, a sensor-linked chapter is generated at a position a predetermined time period a backward from when the presence detection flag changes from ON to OFF, and the sensor-linked chapter management file is updated.

This is a case where the user is absent from the detection area for some time period and returns (Tmin to T0), like when the user goes to the bathroom and returns, or where the presence detection flag changes from OFF to ON within Tmin≦T≦T0.

When the user returns to the detection area, the user may be curious about the missed scene. So, at the timing of the user's return, the ongoing reproduction is continued and at the same time a message is displayed to ask the user whether the user wants to resume reproduction from the position of the sensor-linked chapter indicating the head of the scene that the user may have missed viewing.

The message is similar to that of S608. If the user has chosen to view the missed scene, the sensor-linked chapter management file is referred to, the reproduction position is set to the sensor-linked chapter, and reproduction is resumed.

In this way, at the timing of the user's return, the user can guess what was reproduced while the user was absent, judging from a current scene of the content being reproduced and a thumbnail of the missed scene. Based on the user's guess, the user can decide whether or not to set the reproduction position to the sensor-linked chapter.

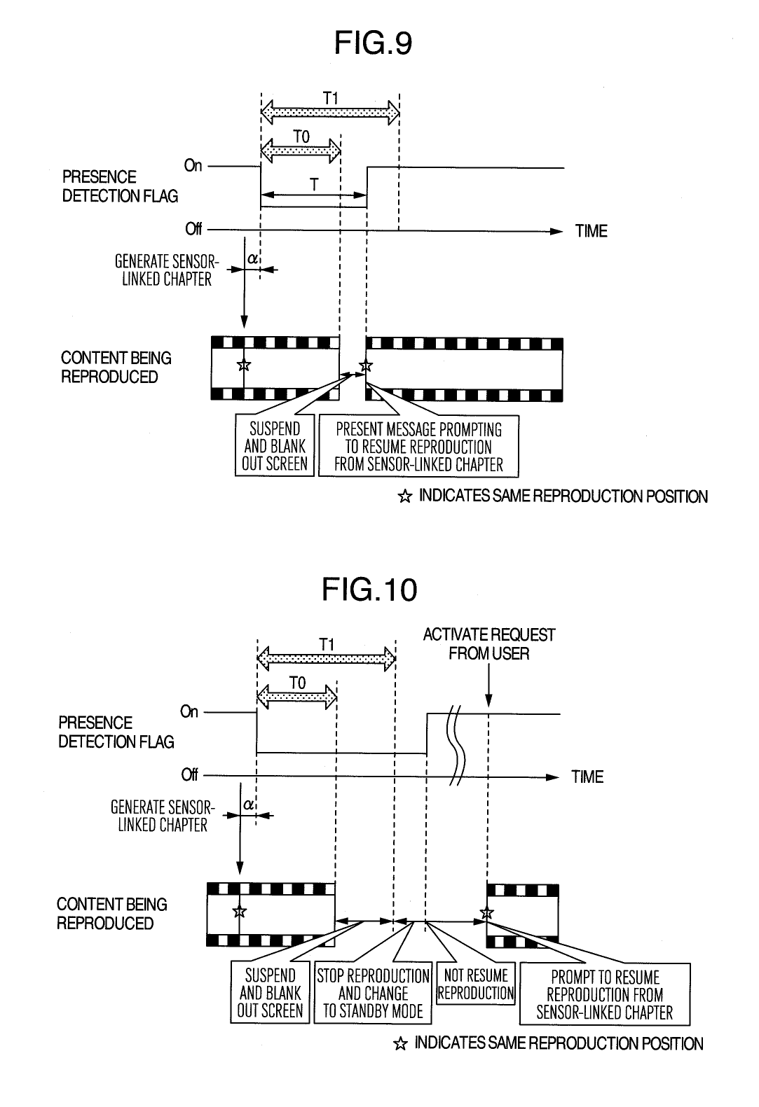

FIG. 9 shows an example of processing performed by the content reproduction apparatus of this embodiment, and, in particular, an example of the content reproduction operation performed by the content reproduction apparatus of this embodiment in the case of T0<T<T1 of FIG. 6.

FIG. 9 shows an example of operation in the sequence of S609, S610, S611 and S612 of FIG. 6 in which the reproduction is suspended while the user was absent for more than T0, and in which the user is prompted to start reproducing from the sensor-linked chapter when resuming reproduction.

According to the sensor-linked chapter generation sequence, a sensor-linked chapter is generated at a position a predetermined time period a backward from when the presence detection flag changes from ON to OFF, and the sensor-linked chapter management file is updated.

For example, if the user goes check up on a crying baby and returns, the content reproduction continues for more than a set time period T0 despite the user not viewing the content and the presence detection flag changes from OFF to ON within T0<T<T1.

In this case, the content reproducing is temporarily suspended and the screen is blanked out. This offers the advantage of reducing power consumption. In this way, at the timing of the user's return, the video is displayed on the screen, and resuming reproduction from the sensor-linked chapter is prompted. An example of the message prompting to resume reproduction is similar to that of S608.

In this case, power consumption can be reduced until the user's return and, when the user returns, reproduction can be resumed from a reproduction position of the sensor-linked chapter indicating the head of the missed scene.

FIG. 10 shows an example of processing performed by the content reproduction apparatus of this embodiment, and, in particular, an example of the content reproduction operation performed by the content reproduction apparatus of this embodiment in the case of T1≦T of FIG. 6.

FIG. 10 shows an example of operation in the sequence of S613, S614, S615 and S616 of FIG. 6 in which the reproduction is suspended from T0 while the user was absent for more than T1, in which, if the “No-view” state further continues, the content reproduction apparatus is set to a standby mode (power saving mode), and in which, if the user issues an activate request, the user is prompted to resume reproduction from the sensor-linked chapter.

According to the sensor-linked chapter generation sequence, a sensor-linked chapter is generated at a position a predetermined time period a backward from when the presence detection flag changes from ON to OFF, and the sensor-linked chapter management file is updated.

For example, if the user has gone out without turning off the power of the content reproduction apparatus or been taking a nap with the content left reproducing as shown in FIG. 10, the content reproduction has continued for more than the set time period T1 despite the user not viewing the content, and the presence detection flag has changed from OFF to ON within T1≦T.

During T0<T<T1, the content reproduction has been temporarily suspended as with FIG. 9 and at the same time the screen is blanked out. During T1≦T, the content reproduction apparatus has been changed to a power saving mode such as a standby mode by stopping reproduction of the HDD, etc.

In this case, even if the user has gone out without turning off the power of the content reproduction apparatus, then the content reproduction apparatus power can be automatically turned off (or set to a standby mode or power saving mode), and a reduction in power consumption can be expected.

At the timing of the user's return, the content reproduction apparatus is not activated, and the video signal is not output to the screen, but at the timing of the user issuing an activate request, the user is prompted to resume reproduction from the sensor-linked chapter. The message prompting to resume reproduction is similar to that of S608.

In this way, it is possible to, at the timing of the user's operation to resume content reproduction because the user wants to do, resume reproduction from a reproduction position of the sensor-linked chapter indicating the head of the scene that the user may have missed viewing.

If a user makes settings of turning the display device on when the user is in front of the content reproduction apparatus (or when the sensor detects the user's presence) irrespective of a timing when the user wants to view the content, the user may set the sensor in a sensing state when the content reproduction apparatus power is turned off (or when it changes to a standby mode or power saving mode) so that the content reproduction apparatus can be changed from the standby mode to the normal display mode if the user is detected in the detection area.

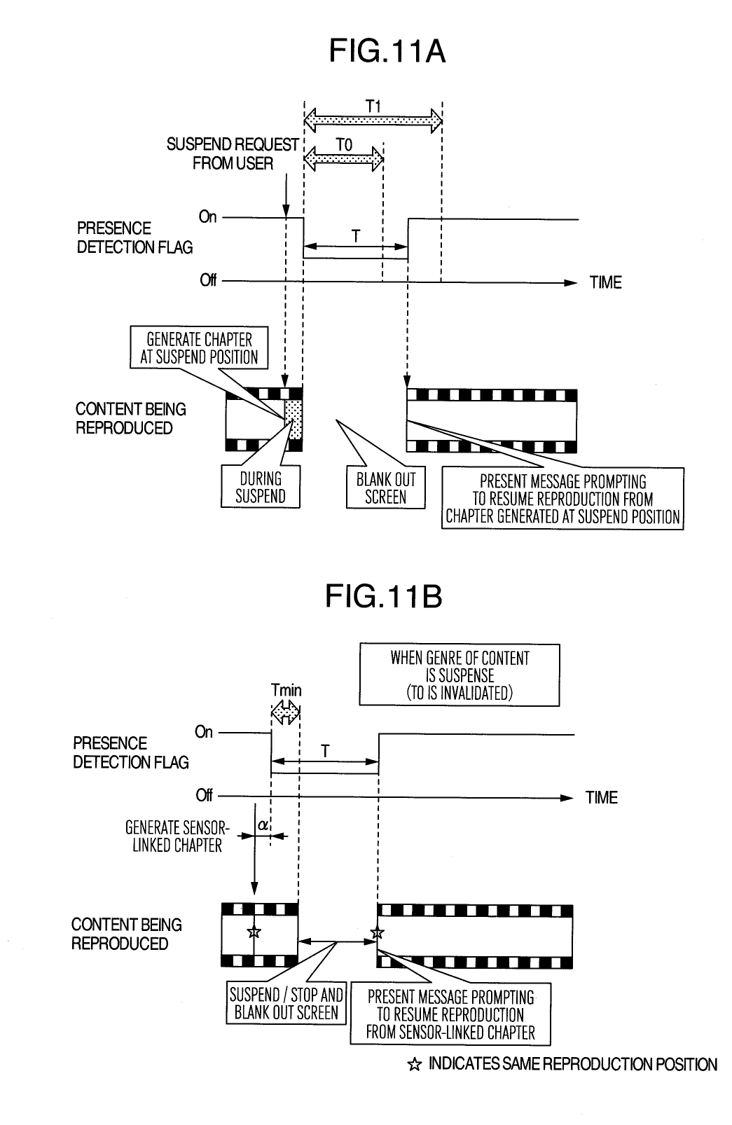

FIG. 11A shows an example of processing performed when the user has done “Suspend” operation of the content being viewed and then leaves the viewing area. In this case, a chapter is generated at a reproduction position reproduced when the “Suspend” operation has been done, and the screen continues to be displayed despite the “Suspend” operation, but the screen is blanked at the timing when the presence detection flag switches from ON to OFF.

In this case, the power consumption can be further reduced by blanking off the screen for the time period T0 after the detection of the user's absence in the sequence of FIG. 6. When the user returns within T0≦T<T1, a message prompting to resume reproduction from the reproduction position at which a chapter was generated when the “Suspend” operation was done is displayed on the screen. At this time, instead of displaying the message prompting to resume reproduction, it is also possible to automatically display the scene at the reproduction position (chapter position) reproduced when the “Suspend” operation was done, or to start reproducing the content from that position. In this case, when the user returns to the viewing area, the user can instruct the processing on the content viewed in the same situation as when the user left the viewing area, or resume reproduction of the content viewed when the user left the viewing area without the user having to do any operation.

FIG. 11B shows the processing for generating a sensor-linked chapter at a position a predetermined time period a backward from when the presence detection flag changes from ON to OFF and blanking off the screen when the time period Tmin elapses without waiting for the time period T0.

For example, where the user watching a suspense drama left the viewing area and returns within the time period T0, the scene on the user's return may reveal the true culprit in the drama, if the screen is not blanked out. So, to prevent from this, the reproduction is suspended and the screen blanked out a short time or Tmin after the user left. This processing may also be performed the time period Tmin or T0 after the user left, depending on the genre of the content being reproduced.

This can realize the content viewing that poses no inconveniences to the user even if the user returns to the viewing area a short time after leaving there. Furthermore, the blanking out of the screen contributes to a reduction in power consumption.

FIG. 12A to FIG. 12F show examples of screen images displaced by the content reproduction apparatus of this embodiment.

FIG. 12A and FIG. 12B show examples of screen images displayed on the screen at timings of S608, S612 and S616 of FIG. 6 to prompt the user to start reproduction from a sensor-linked chapter. FIG. 12A shows an example screen image which, when the user returns within the time period T1 after leaving the viewing area, informs the user that there is a sensor-linked chapter and therefore the user may have missed viewing a scene. If the user wants to view the content from the reproduction position marked by the sensor-linked chapter, the user simply selects a thumbnail picture located in the lower right of the screen to start the reproduction from the chapter.

The message and thumbnail picture are deleted a predetermined time period (e.g., a few seconds) after the sensor has detected the user. The user may continue reproducing the content without rewinding to the chapter-marked scene, or reproducing a current broadcast content.

FIG. 12B shows an example screen image which, when the user returns within time period T1 after leaving the viewing area, presents to the user a current reproduction position in the entire content, existing chapter positions in the content and sensor-linked chapter positions (missed scenes), and asks the user from which position the user wants to resume reproduction.

This allows the user on the user's return from outside the viewing area to select the position from which to view the content, thereby enhancing the usability for the user.

FIG. 12C shows a case where the user selects a list of recorded programs with a remote control, etc., and an example of a screen image displaying sensor-linked chapter positions (missed scenes) in a selected recorded content as thumbnails along with their reproduction positions. The screen image may also present date and time of chapter generation and a time period of missed scenes added to the sensor-linked chapter.

In this way, the time slot and the day of the week when a sensor-linked chapter is set, helps the user decide whether the chapter is the one set when the user left the viewing area (or whether the user missed viewing the scene).

FIG. 12D shows an example of a screen image displayed where a program selected by the user from an electronic program guide (for example by moving a cursor to it) relates to another program already recorded (e.g., a previous episode of a drama series selected by the user). This screen image, by using sensor-linked chapters set in the recorded program, shows how much of the related program the user has missed viewing.

By reference to this screen image used as a criterion, the user can decide whether or not to record the program selected from the electronic program guide; decide whether the user should reproduce and view the recorded relevant program before deciding whether or not to record the selected program from the electronic program guide; or reproduce and view the recorded relevant program after programming recording the selected program. This allows improving the usability for the user.

FIG. 12E and FIG. 12F show examples of screen images which, when the user returns at timings of S608, S612 and S616 of FIG. 6, inform the user that a sensor-linked chapter has been set (or that the user may have missed viewing scenes), by marking the screen image or by lighting or blinking an LED on the content reproduction apparatus.

These screen images inform the user who left the viewing area and returns a predetermined time later that a sensor-linked chapter has been set (or that there is a scene the user may have missed viewing), and, if the user wants to reproduce from a position marked by the sensor-linked chapter, allow the user to jump to the chapter position by the user's predetermined operation such as a chapter rewind operation, so that the user can view the content from that position (the scene considered a missed scene). Even if the user does not want to reproduce from the chapter-marked scene, these screens hardly disturb the user who views the content being reproduced and thus do not annoy the user.

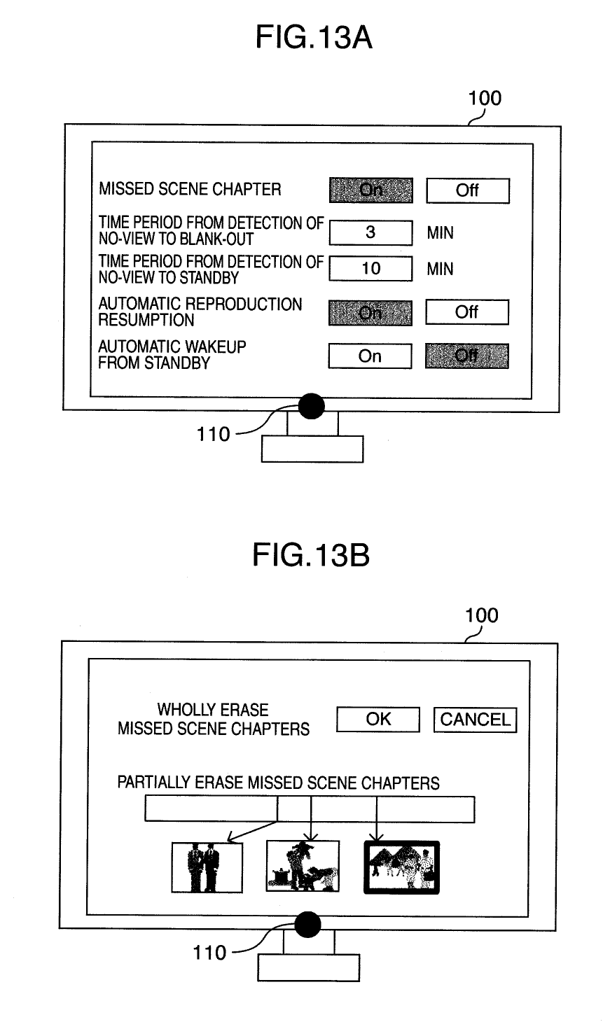

FIG. 13A and FIG. 13B shows examples of screen images displayed by the content reproduction apparatus of this embodiment.

The user can set the availability of functions and parameters in the content reproduction apparatus by using the operation unit 102 such as a remote controller.

In FIG. 13A, “missed-scene chapter” is a sensor-linked chapter. If the “missed-scene chapter” function is set to ON, it is possible to generate a sensor-linked chapter based on a sensor output and to reproduce the content using the chapter. If this function is set to OFF, no chapters are generated based on a sensor output.

“Time period from detection of No-view to Blank-out” is the time period T0 in FIG. 6, etc. If the presence detection flag remains OFF for more than the time period T0, the content reproduction is temporarily suspended and at the same time the screen is blanked out. For example, in a situation where the user has left the viewing area during content reproduction and nobody views the content, the screen is blanked out the time period T0 later.

“Time period from detection of No-view to Standby” is the time period Ti in FIG. 6, etc. In the situation where nobody views the content, the content reproduction apparatus changes to a standby mode the time period T1 later. These time periods can be adjusted according to the user's preferences. They may automatically be determined so as to match respective users by having the content reproduction apparatus learn user's operations.

“Automatic resumption of reproduction” function allows the user to make the following setting. If the presence has not been detected for more than time period T0, the content reproduction is suspended. The “automatic resumption of reproduction” function lets the user decide beforehand whether or not the content reproduction apparatus should automatically rewind to the reproduction position where the sensor-linked chapter is set and start the content reproduction when it is detected that the user returns to the viewing area during reproduction suspension. If this function is set to ON, the content reproduction automatically starts, on the user's return to the viewing area with no user's operation. If this function is set to OFF, the content reproduction apparatus simply presents a message on the screen informing the user that a sensor-linked chapter has been set. To view the missed scene, the user is required to operate the remote controller to request reproduction from the position where the sensor-linked chapter is set.

If “Automatic wakeup from standby” function is set to ON, the sensor is left active in the standby mode which the content reproduction apparatus changes to T1 after the presence detection flag turned OFF. At the timing when the presence detection flag changes from OFF to ON, the content reproduction apparatus automatically turns off standby mode and becomes activated.

As described above, a user can make settings on the availability of various functions in the content reproduction apparatus, and customize the content reproduction apparatus according to the user's preferences. This enhances usability for the user.

FIG. 13B shows how the user can delete the sensor-linked chapters by selecting all or part of chapter information stored in the sensor-linked chapter management file. The sensor-linked chapters are generated in a specified manner according to information on the user, the viewing time slot and the viewing situation, so they may be not as useful for another user as for the first user who generated it. For this reason, when other people first reproduce the content, the content reproduction apparatus may be arranged to allow the second user to erase them because the sensor-linked chapter information left in the content is useless. The erasure by the partial selection of the chapter information allows the user to deliberately delete those chapters that the user does not want to record. Further, when the content strung to the sensor-linked chapter management file is deleted, the sensor-linked chapter management file also may automatically be erased. The sensor-linked chapter management file may be left as is and used as viewer's presence/absence (“View”/“No-view”) detecting information. As other uses, the management file is used to calculate a user's TV viewing time period and a time period for which the TV is left turned on wastefully. The calculated time periods can be presented to the user so that the user can be made aware of the user's TV viewing time period for a predetermined time period such as one day or one week, or of the time slot or period for which TV is left turned on wastefully, and thus the users' energy saving awareness can be enhanced.

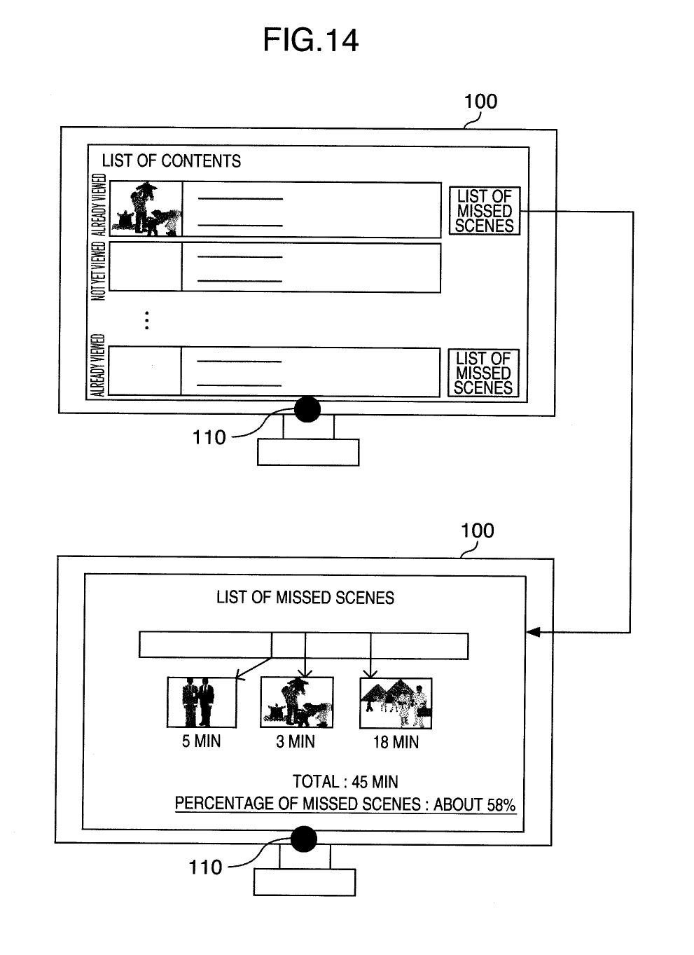

FIG. 14 shows examples screen images of displayed by the content reproduction apparatus of this embodiment.

Take a HDD-mounted TV set for example. Pressing a specific button on the remote controller (e.g., “View” button) causes a list of contents recorded in the HDD to be displayed together with thumbnails and program information.

In the list of recorded contents, a user can mark each content with “Viewed Already” or “Not Yet Viewed” to indicate whether the content has been already viewed or not yet viewed. FIG. 14 shows a configuration example of a “list of missed scenes” icons added to the contents that the user has already viewed.

Selecting the “list of missed scenes” icon causes a list of scenes that are considered to be missed by the user to appear on screen, according to the setting on the sensor-linked chapters and based on the sensor-linked chapter management file generated at a time of the previous content reproduction.

In the content reproduction apparatus, since the time period T for which the presence detection flag remains OFF is measured, a total time period of the scenes that the user may have missed can be calculated. Let us consider a case example where the whole content plays for 45 minutes and where the time period for which the user may have missed viewing the content is calculated to be 5 min+3 min+18 min=26 minutes.

From these figures, a percentage of the missed scenes (26 minutes) in the entire reproduced content (45 minutes) can be calculated (about 58%). Conversely, a percentage of the viewed scenes can also be calculated (100%−58%=42%). Now the user can confirm how much of the reproduced content the user has viewed. When the user decides the user wants to view the remaining 58%, the user can select the content again and view the missed scenes easily using the sensor-linked chapters.

If the user has decided that 42% of the content is enough and deleted the content, this decision can be interpreted to mean that the content is not useful for the user and may be used as information representing the taste or preference of the user. For example, if a content, of which the user has viewed only about 10%, is deleted, then other contents that include as keywords the information such as an anchor, performers, title, or genre found in the program information of the deleted content, may be lowered in user evaluation value. The user evaluation value is a level of evaluation added to individual contents by giving a high rating to a content that includes keywords found in a program that the user often views, etc.

As described above, the sensor-linked chapter information allows not only the missed scenes to be efficiently displayed from the list of missed scenes in the content but also the missed scenes percentage in the content to be used in determining the user evaluation value of the content.

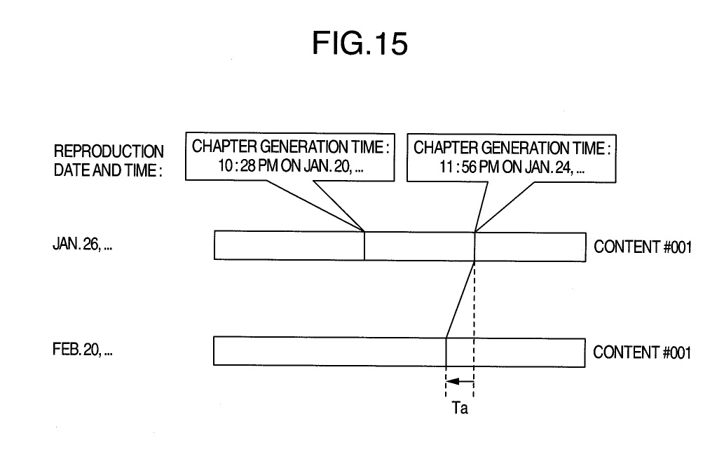

FIG. 15 shows an example of processing performed by the content reproduction apparatus of this embodiment.

This example explains a case where the position of a sensor-linked chapter is changed by using information on chapter generation date and time added to the sensor-linked chapter. For example, the content #001 was reproduced before and has sensor-linked chapters generated at two locations at 10:28 p.m. on January 20, . . . and at 11:56 p.m. on January 24, . . . . When the content #001 was reproduced on January 26, . . . , the sensor-linked chapters are still at the reproduction position where the sensor-linked chapters were generated when the user left the viewing area because it has not been long since the sensor-linked chapters were generated.

Suppose that, on January 26, the missed scene marked by the chapter generated at 10:28 p.m. on January 20 was reproduced. The sensor-linked chapter is erased after the reproduction. If the reproduction on this day finished short of the next missed scene marked by the chapter at 11:56 p.m. on January 24, . . . , this sensor-linked chapter remained.

On February 20, . . . , the user reproduced the content #001 again and selected the chapter generated at 11:56 p.m. on January 24, . . . . In this case, the reproduction begins at a position slightly before where the sensor-linked chapter is recorded, depending on the difference between the clock time when the chapter was generated and the current reproduction time.

This allows the user to view the content from a position slightly before the missed scene so that the user can recall the story although many days have passed since the previous reproduction. If the reproduction starting position shifted slightly before the recorded sensor-linked chapter, falls in a commercial, then the reproduction may start from a position a predetermined time before the commercial by using the chapter immediately before or after the commercial. In this way, the user can view the missed scene in the content efficiently.

### Second Embodiment

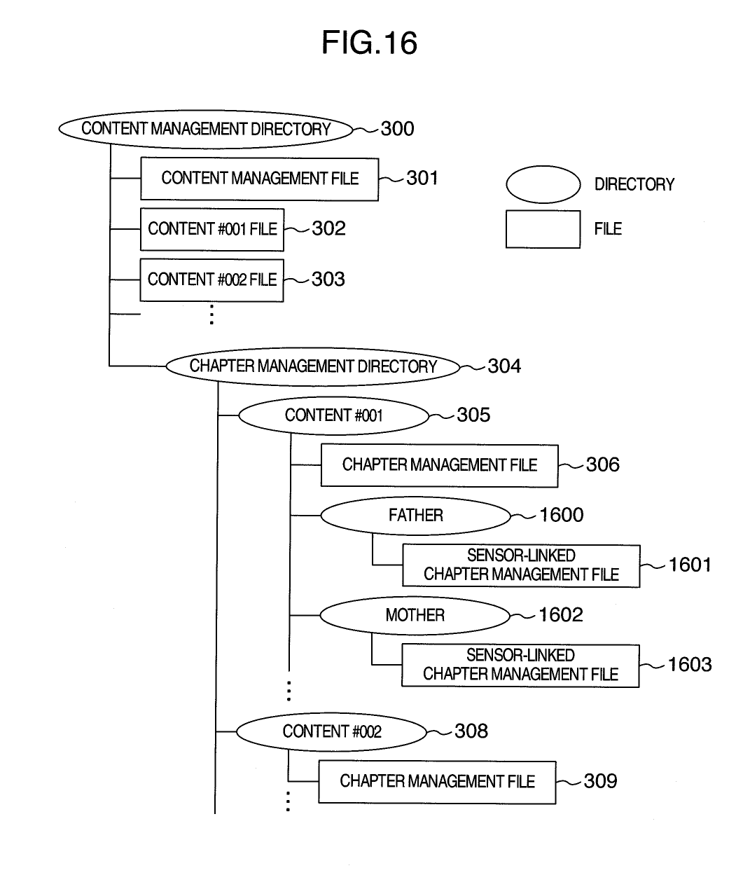

A second embodiment of this invention will be described by referring to FIG. 16 through FIG. 19.

In the first embodiment, sensor-linked chapters are generated in a content being reproduced to facilitate a search for a scene that the user may have missed viewing. The second embodiment has a similar configuration to that of the first embodiment but uses each chapter file structure assigned to each individual so that the content reproduction apparatus can be used by a plurality of viewers.

FIG. 16 shows an example of a chapter file structure generated in the content reproduction apparatus of this embodiment.

This structure is similar to the file structure of FIG. 3 for the first embodiment but has folders, each of which is a folder for a registered user, under each content directory (the content #001, #002, . . . ) in the chapter management directory. In each folder a sensor-linked chapter management file is arranged.

For example, there are the father's folder 1600 which contains the sensor-linked chapter management file 1601, and the mother's folder 1602 which contains the sensor-linked chapter management file 1603. This structure requires the use of a sensor capable of facial identification such as a camera sensor, to identify the user's face in the detection area.

The facial identification technique may utilize a degree of similarity between the face and the body type of the registered user and those of a user in front of the camera, or a difference in facial features (size of eye, nose, mouth, eye brow, human outline, etc., or their positional relation and color). The file structure is arranged to allow a sensor-linked chapter file for each individual to be updated by identifying the individuals and detecting the viewing situation of each individual (e.g., absence, looking away, or nap).

Using genre information of contents and not yet viewed scenes (or oppositely, already viewed scenes) in contents for each individual, it is possible to calculate what genre of contents each individual usually views for how many hours. That is, the percentage of each genre of contents which each individual views can be determined. This can therefore be used as a user evaluation value for each user, and has the advantage that it can be used in recommending contents from a program guide or a group of recorded contents.

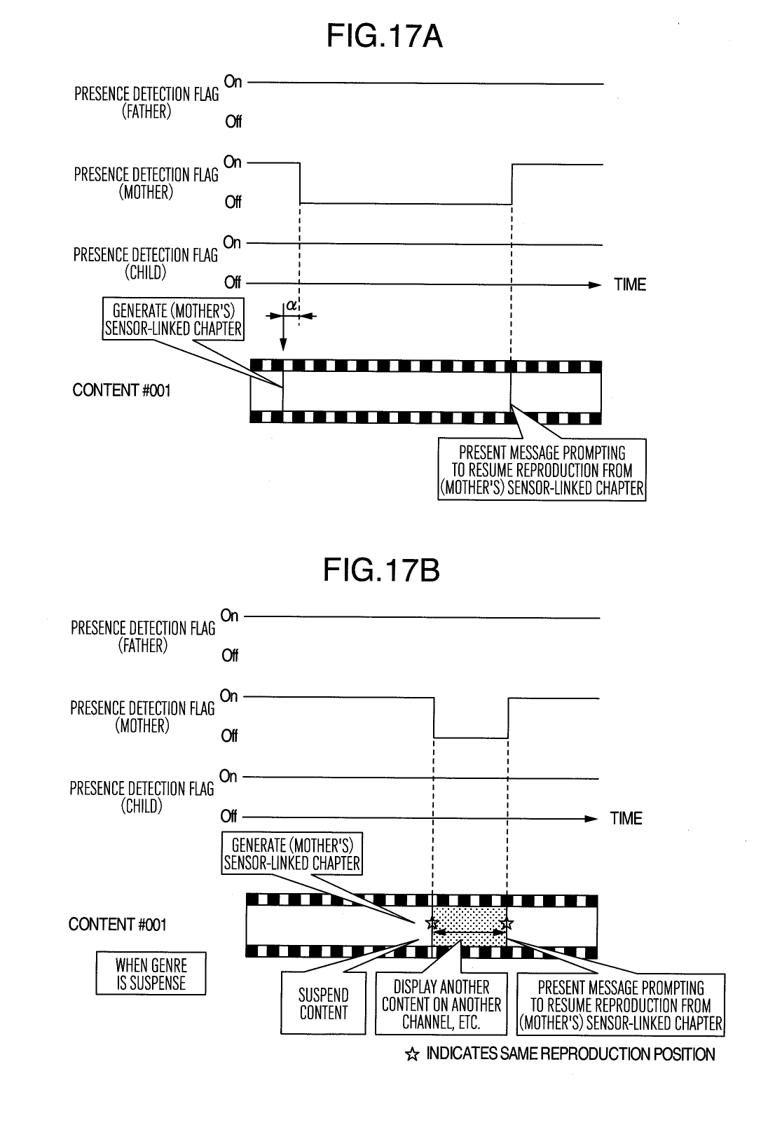

FIG. 17 A and FIG. 17B show examples of processing performed by the content reproduction apparatus of this embodiment. Suppose that, for example, three family members (father, mother and their child) are reproducing and viewing the content #001. When the mother leaves the viewing area for cooking, the presence detection flag for each member is as shown in FIG. 17A. Here, the father and his child keep viewing the content and their sensor-linked chapters are not generated.

So, the sensor-linked chapter management files for the father and child are not updated. The presence detection flag for the mother changes from ON to OFF at the timing when she leaves the detection area, and a sensor-linked chapter is generated at a position a predetermined time period a backward therefrom.

The sensor-linked chapter is generated only in the sensor-linked chapter management file for the mother by using the file structure of FIG. 16. When the mother finishes cooking and returns to the viewing area, the content reproduction apparatus presents on the screen a message reading “Do you want to reproduce again from where was reproduced when Mother left the room?” If the father and child agree, the content is reproduced again from the position of the (mother's) sensor-linked chapter.

However, since the father and child have already viewed the content, the content reproduction apparatus may output a message “The portion that Mother has missed viewing is stored. Mother is advised to reproduce it when viewing the content alone.”, and continue the content reproduction.

Since the sensor-linked chapter management file for the mother has a sensor-linked chapter recorded therein, she, when being alone in the detection area after the current reproduction, may view the missed portion of the content using the sensor-linked chapter.

It is also conceivable to adopt a reproduction method that uses the content genre in the content management file as shown in FIG. 11B. The content reproduction is continued when the mother leaves the viewing area because the father and child are still in the viewing area. But if the genre of the content is mystery/suspense, the continuation of the reproduction poses inconvenience for the mother because she, when returning to the viewing area, can happen to know the ending of the story.

For example, where the genre of the content being reproduced is a specific genre (e.g., mystery/suspense), reproduction may be suspended even if only one of a plurality of users leaves the viewing area, and, when the mother returns to the viewing area, they may be prompted to resume reproduction from the (mother's) sensor-linked chapter.

FIG. 17B shows a case example where, because the father and child have to wait for the suspended period, video programs including currently broadcast programs, EPG other contents available in the HDD, and the Internet contents, are presented on the screen. In this case, because the position of the (mother's) sensor-linked chapter is stored, even if the users select one of the presented contents, the reproduction from the (mother's) sensor-linked chapter can be resumed at any time. In this way, the usability for the user can be improved.

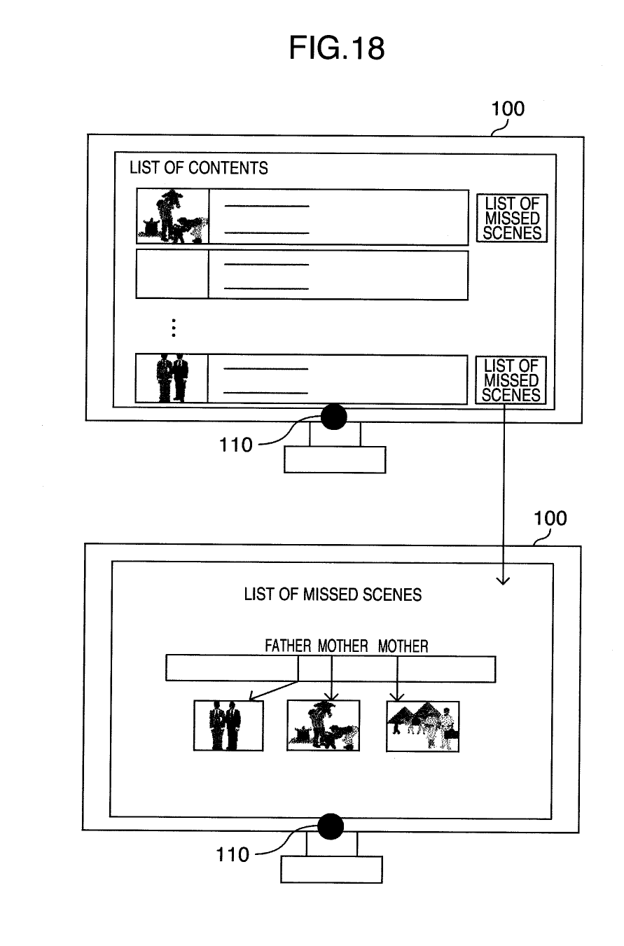

FIG. 18 shows an example of the processing performed by the content reproduction apparatus of this embodiment.

This method of presenting a list of missed scenes is similar to that in FIG. 14, except that the registered user names are shown at chapter positions representing the missed scenes for each user that are extracted from the sensor-linked chapter management file for each user. The users can check not only thumbnails at the chapter positions as shown in FIG. 14, but also the user name added to a particular chapter to see who has missed the scene. For example, this offers the advantage of facilitating searching for a scene that the child has missed viewing.

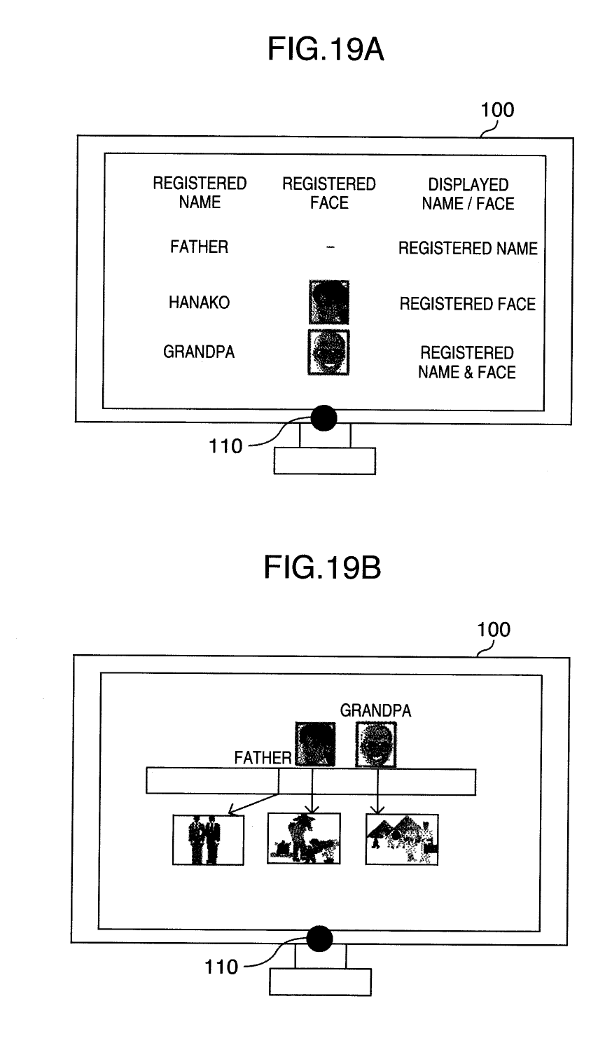

FIG. 19A and FIG. 19B show examples of a screen image displayed in the content reproduction apparatus of this embodiment.

FIG. 19A is a list of registered personal information entered by the user operating a remote controller. Each user is registered using a registration name such as a name or nickname. Where the facial identification is performed by the camera-based image recognition processing, etc., a picture of the user's face taken by the camera can be registered. Further, a prepared facial image of the user or an illustration such as the user's avatar may also be registered as a face for identifying the user.

Where the camera is used to recognize the user, the facial image taken just before the user leaves the viewing area may be stored and used as a registered facial image. Only one of these may be registered. It is also possible to register the method of presenting the information used to identify the registered individual. Each user can choose either the user's registered name or the user's registered facial image for the user's identification to be presented on the screen.

In this example, the father chooses “Father” as his registered name but does not register his face. He chooses the method of presenting his registered name on the screen. His daughter (named Hanako) chooses “Hanako” as her registered name and also registers her face. She chooses to present only her registered face. Grandfather registers “Grandpa” as his registered name and also registered his face. He chooses to present both his registered name and face.

When both the registered name and face are shown, the user may use different registered facial images for the same registered name or combine a different registered name with a different registered facial image. Such personal information may be registered with a password to prevent other users from changing it.

FIG. 19B shows an example of a screen image that presents sensor-linked chapters for all family users. According to the registered method of presenting the information, the information is presented at their personal sensor-linked chapters. On the screen, the father is identified only by his registered name “Father”, Hanako only by her registered facial image, and the grandfather by both his registered name “Grandpa” and his registered facial image. In this way, by thumbnails of the chapters presented on the screen, the user can see at a glance which scenes they have missed viewing.

### Third Embodiment

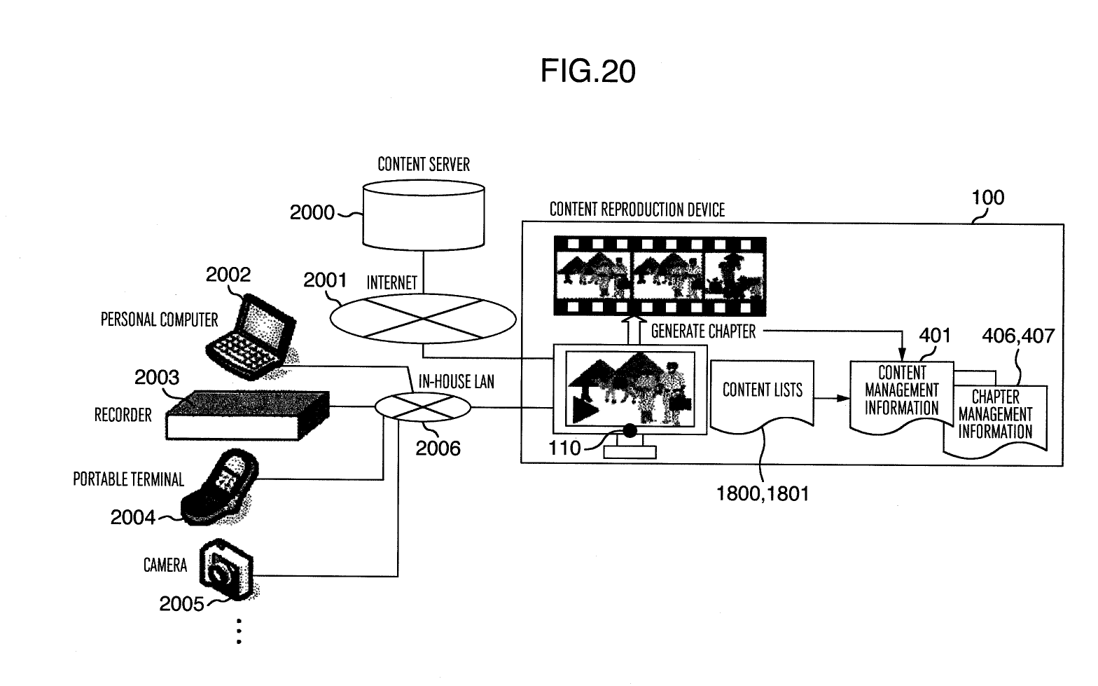

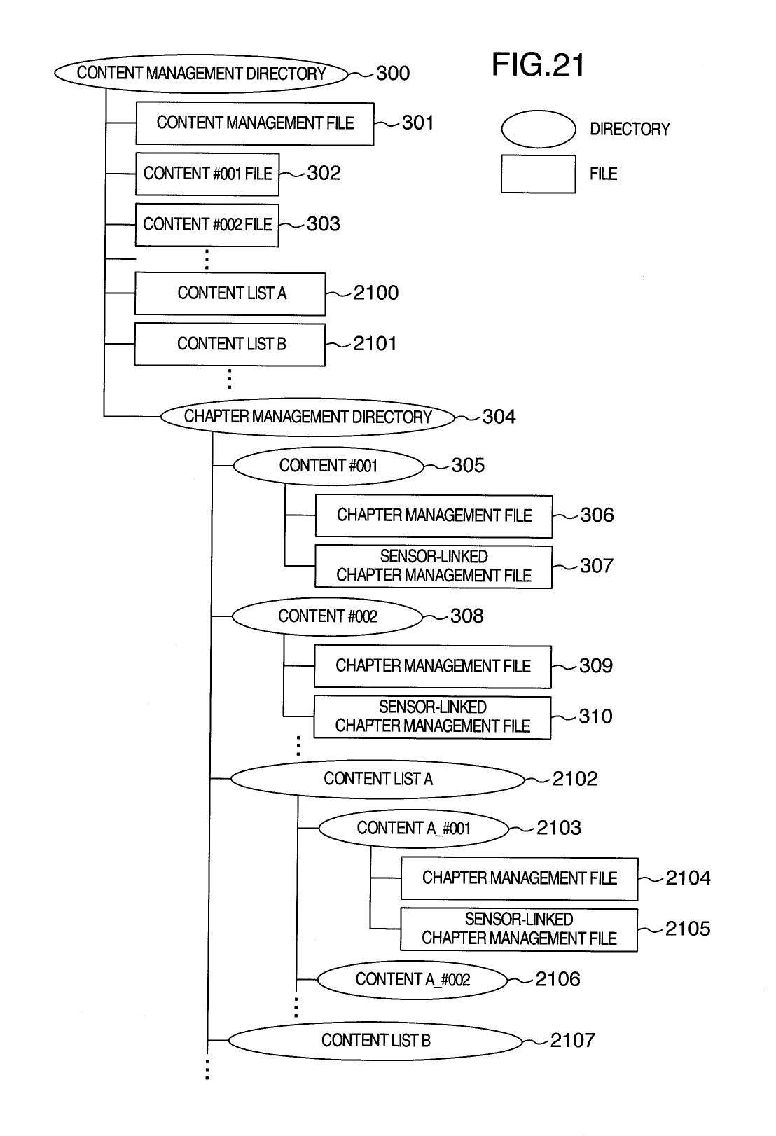

Now, a third embodiment of this invention will be explained by referring to FIG. 20 and FIG. 21.

In the first or second embodiment where a content stored in the content reproduction apparatus is reproduced, the content reproduction apparatus usability is enhanced by generating a sensor-linked chapter. In the third embodiment, a content provided from outside the content reproduction apparatus can be reproduced.

FIG. 20 shows an outline of this embodiment.

The configuration of the content reproduction apparatus is similar to that of the first or second embodiment shown in FIG. 1. To input a network content, the content reproduction apparatus utilizes a wired input (e.g., Ethernet (registered trademark)) or a wireless input (e.g., a network standard in conformity with IEEE802.XX) via the content input unit 101.

The content reproduction apparatus can reproduce a content stored in a content server 2000 such as VOD (Video On Demand) connected to the wide-area Internet 2001. Other devices including personal computers 2002, recorders 2003, portable terminals 2004 such as cell phones and portable game machines, and digital cameras 2005 in conformity with the network standard DLNA (Digital Living Network Alliance), etc. for connecting home appliances, are connected to the content reproduction apparatus through a home network (LAN) (2006) so that the content reproduction apparatus can receive contents and transmit/receive reproduction control signals.

Where these contents are reproduced in the content reproduction apparatus through the network, the content reproduction apparatus needs to refer to content lists held in the respective devices. The content reproduction apparatus retrieves the content lists from the devices through the network and reflects them in the content management information and the chapter management information stored in it.

When the user reproduces contents, the content reproduction apparatus generates sensor-linked chapters by using the sensor mounted on the content reproduction apparatus in a manner similar to the first or second embodiment and also generates sensor-linked chapter management file in each content.

The reproduction control signals such as “Chapter-Jump”, “Reproduction”, “Suspend” and “Stop” are produced during the content reproduction using the sensor-linked chapters and transmitted to the connected device through the network. This allows generating sensor-linked chapters and performing the reproduction control using them even if a content being reproduced is received from outside the content reproduction apparatus.

FIG. 21 shows an example of a chapter file structure generated in the content reproduction apparatus of this example.

This structure is similar to that of the first embodiment in FIG. 3. The content management directory has content lists (the content list A 2100, the content list B 2101) acquired through the network in addition to the content files (#001, #002, . . . ) stored in the HDD. The content management file 301 manages the information on devices having content lists.

In this way, the user can select a content list of the device on the network by doing the same operation as when selecting a content in the HDD. Under the chapter management directory 304, the content list A directory 2102 and the content list B directory 2107 are arranged in the same layer as the content #001 directory 305 and the content #002 directory 308.

Under each content list directory, content directories on the content list (the content A #001 directory 2103 and the content A #002 directory 2106) are arranged. Under each content directory, the chapter management file 2104 and the sensor-linked chapter management file 2105 are arranged.

For example, where, in this file structure, the content A_{—}#001 in the content list A of the device A on the network is reproduced, sensor-linked chapters are generated and the sensor-linked chapter management file 2105 is updated according to the viewing situation of the user in the detection area. This assures the content reproduction with high usability as described in the first or second embodiment.

When a content stored in the HDD of the content reproduction apparatus is reproduced and viewed in the device A on the network, the device A acquires the chapter management file and the sensor-linked chapter management file of the content to be reproduced.

This enables the device A to use the sensor-linked chapters generated during the previous reproduction, and allows reproducing the content efficiently. It is also possible to use the sensor-linked chapters of the viewing user by combining this embodiment with the second embodiment.

Further, when reproducing from the device A using the sensor-linked chapters, the third embodiment may be configured to enable the device A to update the sensor-linked chapter management file stored in the content reproduction apparatus.

This enables the user to view on some remote device those scenes that the user missed viewing on the content reproduction apparatus, and, as the result of viewing it on the remote device, the content reproduction apparatus to delete the chapters for the scenes that the user has finished viewing, thereby facilitating searching for the user's missed scenes.

The above embodiments of this invention have been described for illustrative purposes only and are not intended to limit the scope of this invention to these embodiments. This invention may be implemented in a variety of forms by a person skilled in the art without departing from the spirit thereof.

For example, the above embodiments may be realized by using a camera sensor mounted on a portable terminal to generate sensor-linked chapters while reproducing a content on the portable terminal. This offers the advantage that when a user, while viewing a content in the user's cell phone on a train, is approached and spoken to by an acquaintance and turns the user's face away from the screen, a sensor-linked chapter is automatically generated so that the user can later reproduce it easily from the chapter-marked scene.

Further, the sensor-linked chapter files may be collected and totaled from a plurality of content reproduction apparatuses and the result may be used for a service that calculates the viewer rating of contents. This allows researching the viewer rating of contents.

Programs running on the content reproduction apparatus may be preinstalled in the content reproduction apparatus or provided in the form of a record medium, or downloaded via network. Since there are no limits on the program distribution form, various utilization forms of the content reproduction apparatus become possible. This produces such an effect as to increase the number of users.

Although in the above embodiments only case examples have been explained in which recorded contents are reproduced, the contents to be reproduced are not limited to the recorded contents. This invention is applicable to the content reproduction via Internet channels, the reproduction of server-type broadcast contents through terrestrial waves, etc.

1. A content reproduction apparatus to control content reproduction, comprising:
an input unit to which a content is input;
a reproduction position recording unit to record a reproduction position of a content being reproduced;
a display unit to display the content;
a sensor to detect a human's presence or absence in or from a predetermined area; and
a timer to measure a time period of a human's absence from the predetermined area detected by the sensor;
wherein, if the sensor detects a human's absence from the predetermined area, the reproduction position of the content being reproduced is recorded in the reproduction position recording unit, and, according to the time period measured by the timer, the content reproduction apparatus controls whether or not to display a screen image prompting to start reproducing the content from the reproduction position recorded in the reproduction position recording unit.

2. A content reproduction apparatus according to claim 1, wherein, if the time period measured by the timer is shorter than a predetermined threshold, the screen image prompting to start reproducing the content from the position recorded in the reproduction position recording unit is not displayed.

3. A content reproduction apparatus according to claim 1, wherein, if the time period measured by the timer is longer than a predetermined threshold, the screen image prompting to start reproducing the content from the position recorded in the reproduction position recording unit is displayed.

4. A content reproduction apparatus according to claim 1, wherein, if the time period measured by the timer is longer than a predetermined threshold, the reproduction of the content being reproduced is stopped.

5. A content reproduction apparatus to control content reproduction, comprising:
an input unit to which a content is input;
a reproduction position recording unit to record a reproduction position of a content being reproduced;
a display unit to display the content;
a sensor to detect a human's presence or absence in or from a predetermined area; and
a reproduction control unit to control the reproduction of the content;
wherein, if the sensor detects a human's absence from the predetermined area, the reproduction position of the content being reproduced is recorded in the reproduction position recording unit and, according to a reproduction state of the content, it is controlled whether or not to display a screen image prompting to start reproducing the content from the reproduction position recorded in the reproduction position recording unit.

6. A content reproduction apparatus according to claim 5, wherein, if the reproduction state of the reproduction control unit is a suspend state and the sensor detects a human's absence from the predetermined area, displaying a video on the display unit is stopped.

7. A content reproduction apparatus according to claim 1, wherein the reproduction position of the content recorded in the reproduction position recording unit is a position reproduced a predetermined time before the sensor detected a human's absence from the predetermined area.

8. A content reproduction apparatus according to claim 1, further comprising:
a genre decision unit to determine a genre of the content;
wherein, if the sensor detects a human's absence from the predetermined area, the reproduction of the content being reproduced is stopped according to the genre of the content being reproduced.

9. A content reproduction apparatus according to claim 1, wherein the reproduction position recorded in the reproduction position recording unit is deleted from the reproduction position recording unit when the content has been reproduced from the reproduction position.

10. A content reproduction apparatus according to claim 1, further comprising:
a unit to add, at the reproduction position recorded in the reproduction position recording unit, information on date and time when the reproduction position was recorded;
wherein, according to a time difference between a clock time when the content is about to be reproduced and date and time represented by the information on date and time, a reproduction from the reproduction position recorded in the reproduction position recording unit and a reproduction from a position a predetermined time before the recorded reproduction position are switched.

11. A content reproduction apparatus according to claim 1, further comprising:
a user recognition unit to recognize a user;
wherein information about an individual recognized by the user recognition unit is added at the reproduction position recorded in the reproduction position recording unit.

12. A reproduction player according to claim 1, further comprising:
a device identification unit to identify a device in which the content to be reproduced is recorded; and
a unit to add, at the reproduction position recorded in the reproduction position recording unit, information about the device identified by the device identification unit, the device recording the content to be reproduced.

13. A content reproduction apparatus according to claim 5, wherein the reproduction position recorded in the reproduction position recording unit is a position reproduced a predetermined time before the sensor detected a human's absence from the predetermined area.

14. A content reproduction apparatus according to claim 5, further comprising:
a genre decision unit to determine a genre of the content;
wherein, if the sensor detects a human's absence from the predetermined area, the reproduction of the content being reproduced is stopped according to the genre of the content being reproduced.

15. A content reproduction apparatus according to claim 5, wherein the reproduction position recorded in the reproduction position recording unit is deleted from the reproduction position recording unit when the content has been reproduced from the reproduction position.

16. A content reproduction apparatus according to claim 5, further comprising:
a unit to add, at the reproduction position recorded in the reproduction position recording unit, information on date and time when the reproduction position was recorded;
wherein, according to a time difference between a clock time when the content is about to be reproduced and date and time represented by the information on date and time, a reproduction from the reproduction position recorded in the reproduction position recording unit and a reproduction from a position a predetermined time before the recorded reproduction position are switched.

17. A content reproduction apparatus according to claim 5, further comprising:
a user recognition unit to recognize a user;
wherein information about an individual recognized by the user recognition unit is added at the reproduction position recorded in the reproduction position recording unit.

18. A content reproduction apparatus according to claim 5, further comprising:
a device identification unit to identify a device in which the content to be reproduced is recorded; and
a unit to add, at the reproduction position recorded in the reproduction position recording unit, information about the device identified by the device identification unit, the device recording the content to be reproduced.
